(19) United States
(12) Patent Application Publication
(10) Pub. No.: US 2012/0249622 A1
(43) Pub. Date: Oct. 4, 2012

(54) DISPLAY DEVICE AND DISPLAY METHOD

(75) Inventors: Shigeto Yoshida, Osaka-shi (JP); Kentarou Imamura, Osaka-shi (JP); Hisashi Watanabe, Osaka-shi (JP)

(73) Assignee: SHARP KABUSHIKI KAISHA, Osaka-shi, Osaka (JP)

(21) Appl. No.: 13/512,896

(22) PCT Filed: Oct. 22, 2010
(86) PCT No.: PCT/JP2010/068751

§ 371 Date: May 31, 2012

(30) Foreign Application Priority Data
Dec. 2, 2009 (JP) 2009-274780

(51) Int. Cl. G09G 5/02; G09G 3/36

(52) U.S. Cl. 345/698; 345/89

(57) ABSTRACT

The present invention includes: a view angle data detecting section (28) for detecting a view angle, which is the angle of an observer's line of sight with respect to a display section (40) and preparing view angle data; an interpolation video image data preparing section (20) for preparing, on the basis of the view angle data, an interpolation video image data item, which is a video image data item having a gray scale level that is between respective gray scale levels of individual original video image data items for pixels adjacent to each other; and a control signal generating circuit section (16) for selecting, from original video image data items and the interpolation video image data arranged together, video image data items (i) in a number equal to the number of pixels and (ii) at a substantially equal interval.

### TECHNICAL FIELD

The present invention relates to a display device. In particular, the present invention relates to (i) a display device including a lens on its display surface and (ii) a display method for use in the display device.

### BACKGROUND ART

There has conventionally been proposed a display device that includes a lens on its display surface in order to (i) achieve, in a tiling technique for arranging a plurality of liquid crystal display panels, less visibility for a seam between such liquid crystal display panels (that is, to carry out a seamless display) or to (ii) achieve less visibility for a peripheral part of a liquid crystal display panel and increase the display area of the liquid crystal display panel.

Patent Literature 1, for example, discloses a technique of (i) providing a convex lens on the display surface of a display device to make its peripheral part less visible and (ii) in order to prevent an extended display of an image, reducing a pixel pitch in a region of the display device which region corresponds to a curved portion of the convex lens.

Patent Literature 2 discloses a technique of (i) providing convex lenses on the respective display surfaces of a plurality of arranged display devices and (ii) determining a focal length for each of the convex lenses for display of an enlarged virtual image. This technique thus makes a seam between the display devices less visible.

### CITATION LIST

### Patent Literature 1

Japanese Patent Application Publication (Translation of PCT Application), Tokuhyou, No. 2004-524551 A (Publication Date: Aug. 12, 2004)

### Patent Literature 2

Japanese Patent Application Publication, Tokukaihei, No. 3-5787 A (Publication Date: Jan. 11, 1991)

### SUMMARY OF INVENTION

### Technical Problem

The technique disclosed in Patent Literature 1 is, however, problematic in that (i) it is not easy to change a pixel pitch in correspondence with a curve of a convex lens during production and that (ii) this technique thus requires highly precise positioning in providing a convex lens.

The above technique is further problematic in that it (i) requires redesign of a liquid crystal display panel in the case of changing the radius of curvature of a lens in correspondence with the application and (ii) is poor in versatility because a display device produced by this technique cannot be diverted as a display device for a different application if provided with no lens.

Patent Literature 1, assuming that the view angle is not a normal direction, discloses a display method involving a repeat of a portion of an image between adjacent display devices (that is, a method of displaying a partially identical image for adjacent portions). This method is, however, problematic in that (i) it is low in the effect of causing images to look continuous with one another and that (ii) this method does not optimize the view angle at all.

The technique disclosed in Patent Literature 2 is also problematic in that (i) it tends to result in a large-sized display device and that (ii) since this technique designs a display device to form a virtual image at such a position as to make a seam less visible, it tends to limit the position at which a virtual image is displayed.

The present invention has been accomplished to solve the above problems. It is an object of the present invention to provide (i) a display device that is high in versatility, easy to produce, and capable of preventing an extended display with use of a simple configuration and (ii) a display method.

### Solution to Problem

In order to solve the above problems, a display device of the present invention includes: a display section; and an optical section covering a display surface of the display section, the display section including a plurality of pixels arranged in a matrix, the optical section including a lens having (i) a flat region having a flat front surface and (ii) a curved region having a curved convex front surface, video image data items for the plurality of respective pixels being a plurality of original video image data items, the display device further including: a view angle data detecting section for detecting a view angle, which is an angle for a line of sight by an observer with respect to the display section, so as to prepare view angle data; an interpolation video image data preparing section for preparing, on a basis of the view angle data, an interpolation video image data item, which is a video image data item having a gray scale level that is between respective gray scale levels of individual original video image data items for pixels adjacent to each other; and a control section for selecting, from video image data items combining (i) the plurality of original video image data items arranged in an order of respective pixels corresponding to the plurality of original video image data items and (ii) the interpolation video image data item located between original video image data items for respective corresponding pixels so that a gray scale level of the interpolation video image data item is continuous with respective gray scale levels of the original video image data items for the respective corresponding pixels, video image data items (i) in a number equal to a number of the pixels and (ii) at a substantially equal interval.

A display method of the present invention is a method for use in a display device, the display device including: a display section; and an optical section covering a display surface of the display section, the display section including a plurality of pixels arranged in a matrix, the optical section including a lens having (i) a flat region having a flat front surface and (ii) a curved region having a curved convex front surface, video image data items originally corresponding to the plurality of respective pixels being a plurality of original video image data items, the method including the steps of: detecting a view angle, which is an angle for a line of sight by an observer with respect to the display section, so as to prepare view angle data; preparing, on a basis of the view angle data, an interpolation video image data item, which is a video image data item having a gray scale level that is between respective gray scale levels of individual original video image data items for pixels adjacent to each other; selecting, from video image data items combining (i) the plurality of original video image data items arranged in an order of respective pixels corresponding to the plurality of original video image data items and (ii) the interpolation video image data item located between original video image data items for respective corresponding pixels so that a gray scale level of the interpolation video image data item is continuous with respective gray scale levels of the original video image data items for the respective corresponding pixels, video image data items (i) in a number equal to a number of the pixels and (ii) at a substantially equal interval; and displaying the selected video image data items.

A video image displayed by pixels is enlarged when viewed through a lens having a convex curved surface. A video image displayed by a display section thus tends to be an extended display, which is a display produced by enlarging a video image that is originally supposed to be displayed. Further, the rate at which a display is magnified varies according to the angle for an observer's line of sight with respect to the display surface.

The above arrangement and method each prepare, on the basis of view angle data, which is information on the angle for the observer's line of sight, an interpolation video image data item, which is a video image data item having a gray scale level that is between respective gray scale levels of individual original video image data items for pixels adjacent to each other.

The above arrangement and method each (i) arrange original video image data items in an order of respective pixels corresponding thereto and (ii) locate the interpolation video image data item between original video image data items for respective corresponding pixels so that the gray scale level of the interpolation video image data item is continuous with those of the original video image data items for the respective corresponding pixels. Thus, that video image data group is a group of video image data items that are, when displayed through a lens, not likely to result in an extended display regardless of the angle for the observer's line of sight. The above arrangement and method further each select, from the original video image data items and the interpolation video image data item arranged as above, video image data items (i) in a number equal to the number of the pixels corresponding to the original video image data items and (ii) at a substantially equal interval. The above arrangement and method thus each carry out a display on the basis of the selected video image data.

In other words, the video image data to be displayed is video image data thinned out at a substantially equal interval from a video image data group that takes, into consideration, magnification of a video image by a lens. This makes it possible to (i) carry out a more natural, highly continuous display through a lens and consequently (ii) prevent an extended display.

The above substantially equal interval intends to include, in meaning, selecting, in the case where it is impossible to select video image data items at an accurately equal interval due to the relation between (i) the number of original video image data items and interpolation video image data items and (ii) the number of pixels, video image data items as appropriate to achieve an interval that is as close as possible to an accurately equal interval.

The above arrangement and method each, in order to prevent an extended display, involve no arrangement or method, such as changing the size or pitch of pixels, that makes production difficult or that complicates the structure.

The above arrangement and method, each of which allows an easy change to, for example, (i) the number of interpolation video image data items to be prepared and (ii) gray scale levels, are so high in versatility as to easily use any of various lenses. Further, the above arrangement and method, each of which prepares interpolation video image data in correspondence with the observer's view angle, are so high in versatility as to prevent an extended display even if the observer's view angle changes variously.

As described above, the above arrangement and method each provide (i) a display device that is high in versatility, easy to produce, and capable of preventing an extended display with use of a simple configuration and (ii) a display method.

### Advantageous Effects of Invention

As described above, a display device of the present invention includes: a display section; and an optical section covering a display surface of the display section, the display section including a plurality of pixels arranged in a matrix, the optical section including a lens having (i) a flat region having a flat front surface and (ii) a curved region having a curved convex front surface, video image data items for the plurality of respective pixels being a plurality of original video image data items, the display device further including: a view angle data detecting section for detecting a view angle, which is an angle for a line of sight by an observer with respect to the display section, so as to prepare view angle data; an interpolation video image data preparing section for preparing, on a basis of the view angle data, an interpolation video image data item, which is a video image data item having a gray scale level that is between respective gray scale levels of individual original video image data items for pixels adjacent to each other; and a control section for selecting, from video image data items combining (i) the plurality of original video image data items arranged in an order of respective pixels corresponding to the plurality of original video image data items and (ii) the interpolation video image data item located between original video image data items for respective corresponding pixels so that a gray scale level of the interpolation video image data item is continuous with respective gray scale levels of the original video image data items for the respective corresponding pixels, video image data items (i) in a number equal to a number of the pixels and (ii) at a substantially equal interval.

As described above, a display method of the present invention for use in a display device is a method for use in a display device, the display device including: a display section; and an optical section covering a display surface of the display section, the display section including a plurality of pixels arranged in a matrix, the optical section including a lens having (i) a flat region having a flat front surface and (ii) a curved region having a curved convex front surface, video image data items originally corresponding to the plurality of respective pixels being a plurality of original video image data items, the method including the steps of: detecting a view angle, which is an angle for a line of sight by an observer with respect to the display section, so as to prepare view angle data; preparing, on a basis of the view angle data, an interpolation video image data item, which is a video image data item having a gray scale level that is between respective gray scale levels of individual original video image data items for pixels adjacent to each other; selecting, from video image data items combining (i) the plurality of original video image data items arranged in an order of respective pixels corresponding to the plurality of original video image data items and (ii) the interpolation video image data item located between original video image data items for respective corresponding pixels so that a gray scale level of the interpolation video image data item is continuous with respective gray scale levels of the original video image data items for the respective corresponding pixels, video image data items (i) in a number equal to a number of the pixels and (ii) at a substantially equal interval; and displaying the selected video image data items.

The above arrangement and method each advantageously provide (i) a display device that is high in versatility, easy to produce, and capable of preventing an extended display with use of a simple configuration and (ii) a display method.

### BRIEF DESCRIPTION OF DRAWINGS

FIG. 1 is a diagram illustrating a display device of the present invention as viewed in a direction toward its display surface.

FIG. 2 is a cross-sectional view taken along line A-A in FIG. 1 in accordance with a reference embodiment for the present invention.

FIG. 3 is a block diagram schematically illustrating a configuration of a liquid crystal display device of the reference embodiment for the present invention.

FIG. 4 is a diagram illustrating how a lens magnifies a display in accordance with the reference embodiment for the present invention.

FIG. 5 is a diagram illustrating how a display region is extended in accordance with the reference embodiment for the present invention.

FIG. 6 is a diagram illustrating original video image data and interpolation video image data in accordance with the reference embodiment for the present invention.

FIG. 7 is a diagram schematically illustrating how interpolation video image data is prepared in accordance with the reference embodiment for the present invention.

FIG. 8 is a diagram illustrating how an interpolation number is determined in accordance with the reference embodiment for the present invention.

FIG. 9 is a diagram illustrating a region for which interpolation video image data is prepared in accordance with the reference embodiment for the present invention.

FIG. 10 is a diagram illustrating how an interpolation number is determined in accordance with the reference embodiment for the present invention.

FIG. 11 is a diagram illustrating a region for which interpolation video image data is prepared in accordance with the reference embodiment for the present invention.

FIG. 12 is a diagram illustrating a region for which interpolation video image data is prepared in accordance with the reference embodiment for the present invention.

FIG. 13 is a diagram illustrating how thinned-out video image data is selected in accordance with the reference embodiment for the present invention.

FIG. 14 is a graph illustrating a relation between the radius of curvature of a lens and a lens width in accordance with the reference embodiment for the present invention.

FIG. 15 shows diagrams each illustrating how a change in the view angle of an observer changes the region in which a display is extended, where (a) is a diagram illustrating a display device being viewed in the direction normal thereto (that is, at a view angle of 90°), and (b) is a diagram illustrating a display device being viewed in a direction inclined at an angle (that is, a view angle p) from the normal direction.

FIG. 16 is a block diagram schematically illustrating a configuration of a liquid crystal display device of Embodiment 1 of the present invention.

FIG. 17 is a diagram illustrating how a pixel is extended in accordance with Embodiment 1 of the present invention.

FIG. 18 is a diagram illustrating a relation between an open angle and a view angle for a liquid crystal display device in accordance with Embodiment 1 of the present invention, where (a) schematically illustrates a configuration of a fold-type liquid crystal display device and the direction of a user's line of sight with respect to the fold-type liquid crystal display device, and (b) illustrates a relation, observed in the fold-type liquid crystal display device in the state illustrated in (a), between (i) an open angle between a liquid crystal display panel and an operating section and (ii) the user's view angle.

FIG. 19 shows diagrams each illustrating how to detect an open angle for a liquid crystal display device in accordance with Embodiment 1 of the present invention, where (a) is an elevational view illustrating a liquid crystal display panel and an operating section of a fold-type liquid crystal display device, and (b) is a side view illustrating the liquid crystal display panel and the operating section of the fold-type liquid crystal display device.

FIG. 20 shows diagrams each illustrating how to detect an open angle for a liquid crystal display device in accordance with Embodiment 1 of the present invention, where (a) is an elevational view illustrating a liquid crystal display panel and an operating section of a fold-type liquid crystal display device, and (b) is a side view illustrating the liquid crystal display panel and the operating section of the fold-type liquid crystal display device.

FIG. 21 is a diagram illustrating how to detect a view angle for a liquid crystal display device in accordance with Embodiment 1 of the present invention.

FIG. 22 is a diagram illustrating how to detect an open angle for a liquid crystal display device in accordance with Embodiment 1 of the present invention.

FIG. 23 shows diagrams each schematically illustrating a liquid crystal display device of Embodiment 2 of the present invention, (a) illustrates a case in which two liquid crystal display panels form an open angle of 180°, (b) illustrates a case in which two liquid crystal display panels form an open angle of 120°, and (c) illustrates a relation between an open angle and a view angle for the two liquid crystal display panels.

FIG. 24 is a block diagram schematically illustrating a configuration of a liquid crystal display device of Embodiment 2 of the present invention.

FIG. 25 is a diagram illustrating a relation between an open angle and a view angle for a liquid crystal display device in accordance with Embodiment 2 of the present invention.

### DESCRIPTION OF EMBODIMENTS

Embodiments of the present invention are described below in detail.

The description below first deals with (i) as a reference embodiment for the present invention, a technique used in a display device capable of preventing an extended display, and then with (ii) the embodiments of the present invention that are based on that technique.

### Reference Embodiment

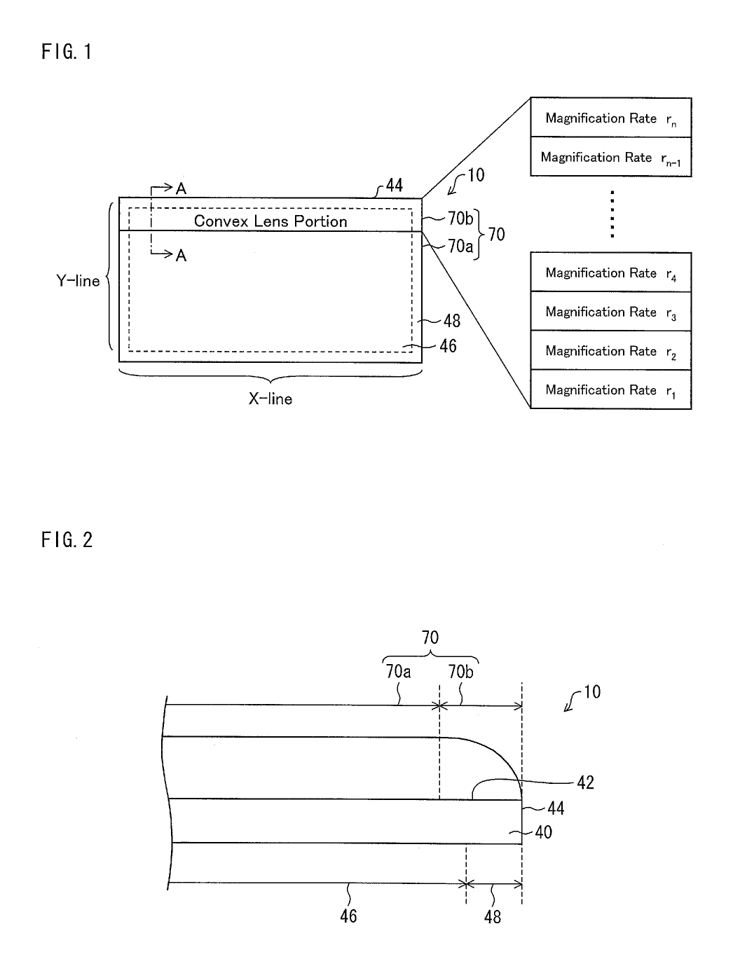

The reference embodiment is described below with reference to FIGS. 1 through 14.

(Display Device)

FIG. 1 is a diagram schematically illustrating a configuration of a liquid crystal display device of the present embodiment as viewed in a direction toward its display surface. FIG. 2 is a cross-sectional view taken along line A-A in FIG. 1.

As illustrated in FIG. 1, the display device of the present embodiment is a liquid crystal display device 10 having a display surface covered by a lens 70 serving as an optical section.

The lens 70 includes (i) a flat region 70a having a flat surface, and (ii) a curved region 70b having a curved surface and thus functioning as a convex lens. The curved region 70b is provided along a long side, that is, one side among the four sides of the rectangular display surface.

The description below refers to the cross section illustrated in FIG. 2. The liquid crystal display device 10, as illustrated in FIG. 2, includes: a liquid crystal display panel 40 serving as a display section; and a lens 70 provided on a display surface 42 of the liquid crystal display panel.

The liquid crystal display panel 40 includes pixels (not shown) arranged in a matrix, the pixels forming lines crossing each other at right angle.

The curved region 70b of the lens 70 is provided in the vicinity of an end side 44 of the liquid crystal display panel 40.

The display surface 42 includes (i) a display region 46 in which a video image and the like are displayed and (ii) a non-display region 48, such as a so-called frame, that is a region in which a video image and the like are not displayed. The lens 70 is so provided that the curved region 70b overlaps both the display region 46 and the non-display region 48.

FIGS. 1 and 2 each illustrate the curved region 70b as being provided along a long side among the four sides of the display surface. The present embodiment is, however, not particularly limited in terms of, for example, the position of the curved region 70b in the lens 70 or the number of curved regions 70b. The curved region 70b may, for instance, be provided along a short side among the four sides of the display surface. The curved region 70b may further be provided, not only along one end side, but also along two to four sides.

Further, the lens 70 does not necessarily include a flat region 70a. The lens 70 may alternatively, for instance, include no flat region 70a, but include a curved region 70b throughout itself.

(Overall Configuration)

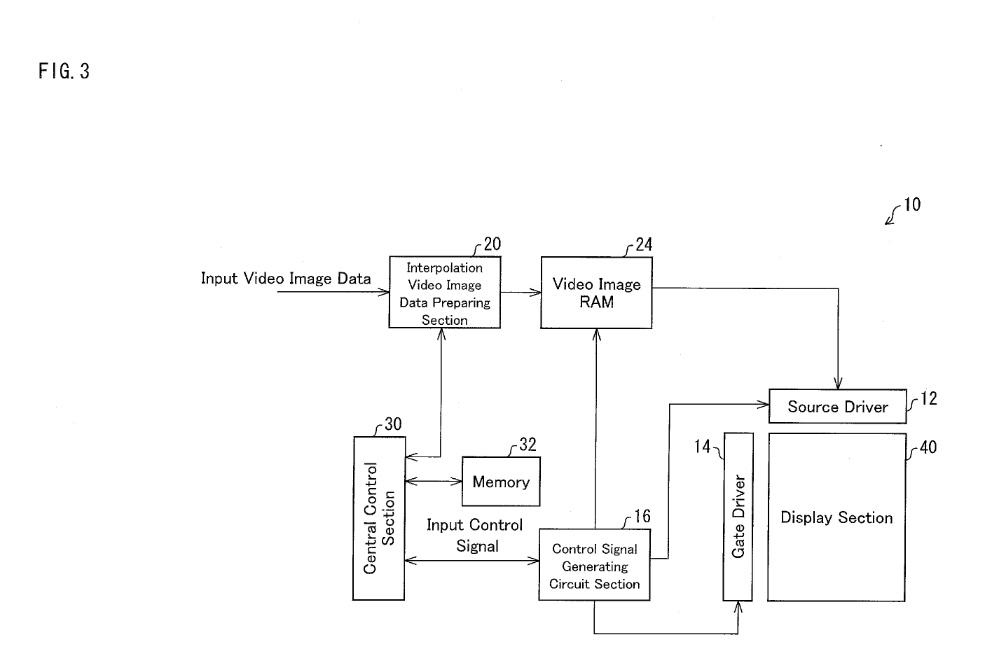

The description below now deals with an overall configuration of the liquid crystal display device 10 of the present embodiment with reference to FIG. 3. FIG. 3 is a block diagram schematically illustrating a configuration of the liquid crystal display device 10.

The liquid crystal display device 10 of the present embodiment includes various control sections and the like in addition to the liquid crystal display panel 40 serving as the display section.

Specifically, the liquid crystal display device, as illustrated in FIG. 3, includes a source driver 12 and a gate driver 14 both in a region surrounding the liquid crystal display panel 40.

The liquid crystal display device 10 further includes: a video image RAM 24 that stores video image data to be supplied to the source driver 12; and an interpolation video image data preparing section 20 connected to the video image RAM 24.

The interpolation video image data preparing section 20 prepares interpolation video image data described below. The video image RAM 24 stores (i) input video image data, that is, original video image data, and (ii) the interpolation video image data.

The original video image data (that is, video image data originally corresponding to individual pixels) refers to video image data that is supposed to be supplied to individual pixels. Specifically, the original video image data refers to, for example, video image data that would be supplied to individual pixels in a normal display device including no optical section.

The video image data (namely, the original video image data and the interpolation video image data) is temporarily stored in the video image RAM, and is then supplied from the video image RAM 24 to the source driver 12.

The liquid crystal display device 10 further includes a control signal generating circuit section 16 that controls the source driver 12, the gate driver 14, and the video image RAM 24.

The control signal generating circuit section 16 functions also as a control section for selecting, from the video image data stored in the video image RAM 24, video image data to be supplied to the source driver 12 (that is, selecting thinned-out video image data).

The control signal generating circuit section 16 receives an input control signal for control of the above selection.

The liquid crystal display device 10 further includes: a memory 32 that stores display control programs for performing the above control and the like; and a central control section 30 connected to the memory 32.

The central control section 30 controls the control signal generating circuit section 16 by supplying an input control signal thereto, and also controls the interpolation video image data preparing section 20.

(Display Method)

The description below sequentially deals with individual aspects of a display method for use in the liquid crystal display device of the present embodiment.

(Magnification Factor)

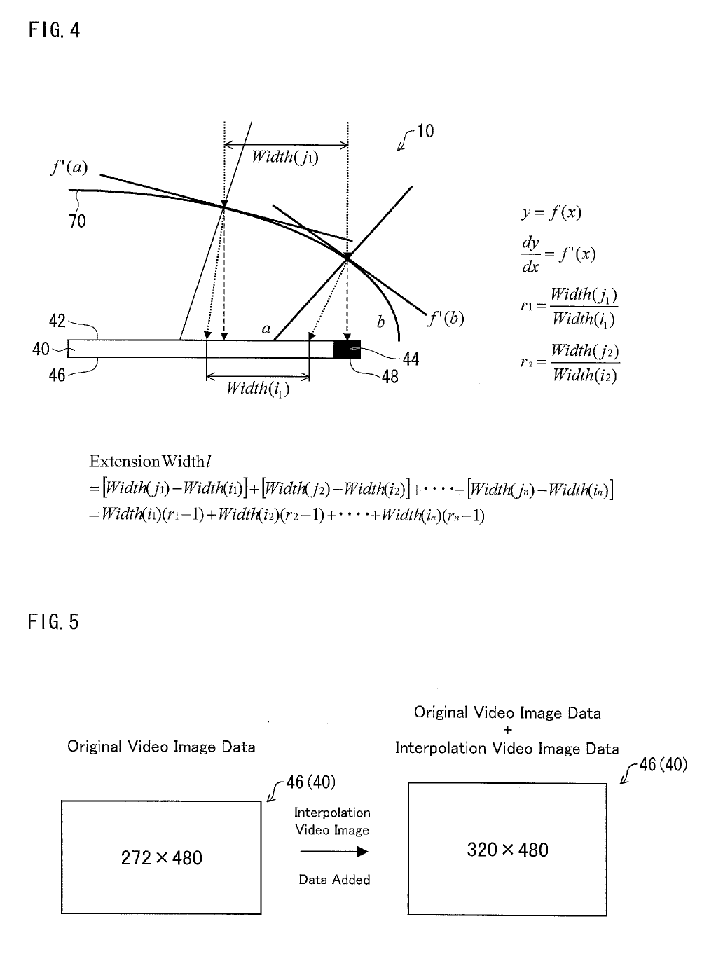

FIG. 4 is a diagram illustrating how the lens 70 magnifies a display.

In FIG. 4, Width(in) represents the width of a certain line zone (that is, the length of a portion of the display surface) as viewed in a direction normal to the display surface 42.

Width(jn) represents the width of the line zone (that is, the length of the portion of the display surface) for a case in which Width(in) is displayed through the lens 70.

Width(jn)/Width(in) gives a magnification factor rn for that line zone, that is, the rate at which a video image is magnified through the lens 70 serving as the optical section.

The magnification factor rn varies according to how the lens 70 is curved. Thus, as illustrated in FIG. 1 referred to above, the magnification factor rn varies for each line within the range from the boundary between the flat region 70a and the curved region 70b to the end side 44.

(Extension Width)

The description below now deals with the width by which a line zone is extended by the lens 70.

The extension width I by which a line zone is extended by the lens 70 is given by Width(jn)−Width(in).

The extension width I for the entire curved region 70b is found by adding up all “Width(jn)−Width(in)” values for that entire region as shown in the mathematical formula in FIG. 4.

f(x) in FIG. 4 is a function representative of the shape of a surface of the lens 70. f′(x) represents the inclination of f(x).

f′(a) and f′(b) in FIG. 4 represent respective inclinations of the surface of the lens 70 at positions a and b.

(Video Image RAM)

The description below deals with the capacity of the video image RAM 24. The video image RAM 24 stores video image data, which includes (i) original video image data and (ii) interpolation video image data prepared in addition to the original video image data. In other words, the video image RAM 24 is so configured as to function as a RAM for storing video image data for up-converting a video image.

The video image RAM 24 requires a capacity to store the above video image data which capacity is approximately calculated on the basis of the number of extension lines to be added. The number of extension lines to be added can be calculated by the equation below.

Number of extended lines to be added=extension width/pixel pitch (line pitch)

In the case where the lens 70 is a convex lens that is curved in a vertical-line direction with respect to the liquid crystal display panel 40, a video image displayed is extended to a degree corresponding to the radius of curvature of the lens 70. The width of the extended portion of the video image is calculated as an extension width, which is then divided by the length of the pixel pitch to find the number of extension lines to be added. The above extension width is, if expressed in terms of the length of the display surface, the difference between (i) the length of a portion of the display surface 42 which portion faces the curved region 70b and (ii) the length of that portion as viewed through the lens 70.

Specifically, in the case where, for instance, a liquid crystal display panel 40 including a display region 46 having 272 vertical lines and 480 horizontal lines displays a video image that is extended by the above convex lens to have 320 vertical lines after the video image extension as illustrated in FIG. 5, the difference is found as below.

The difference between 320 lines and 272 lines is 52 lines, which is the number of extension lines to be added in the above case. Such a number of extension lines to be added can determine the capacity of the video image RAM 24.

Specifically, in the case of, for instance, an RGB display having eight gray scale levels, the video image RAM 24 needs to have a capacity corresponding to the number of bits calculated by the following equation:

Number of bits=52 (number of extension lines)×480 (number of vertical lines)×8 (number of gray scale bits)×3 (R, G, and B)

(Interpolation Video Image Data)

The description below deals with interpolation video image data, which refers to video image data prepared to fill a void formed as a result of video image extension by the lens 70.

In other words, interpolation video image data refers to data so prepared in a pseudo manner as to, in a display region corresponding to a void formed as a result of video image extension by the lens 70, display a video image having a line zone substantially equal in width to such a void. Combining such interpolation video image data with original video image data, even in the case where the lens 70 has caused a video image to be extended by an extension width, allows prepared video image data to have, in a portion corresponding to the curved region 70b of the lens 70, a density that is substantially equal to that for a portion corresponding to the flat region 70a.

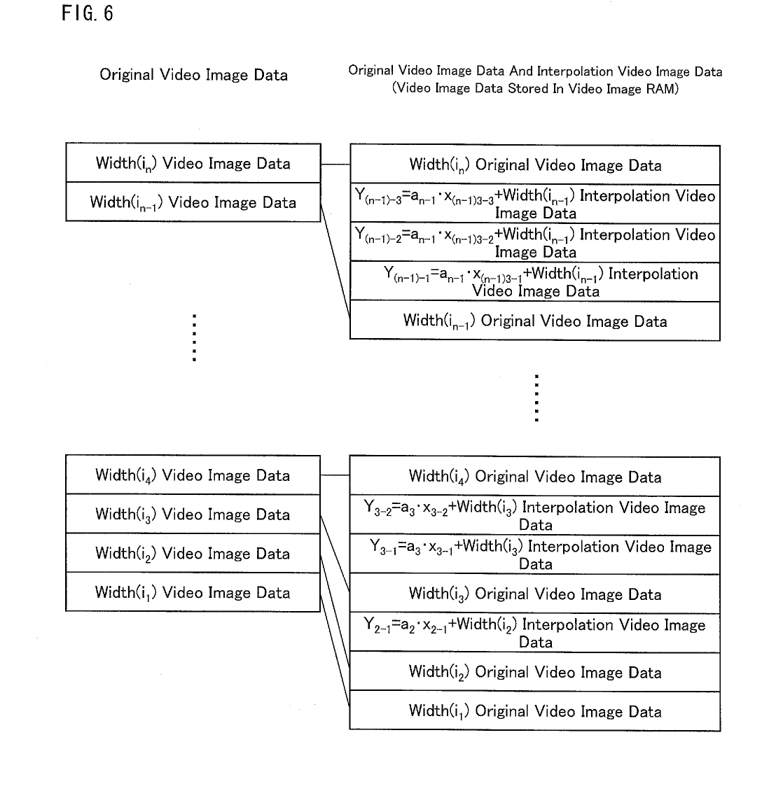

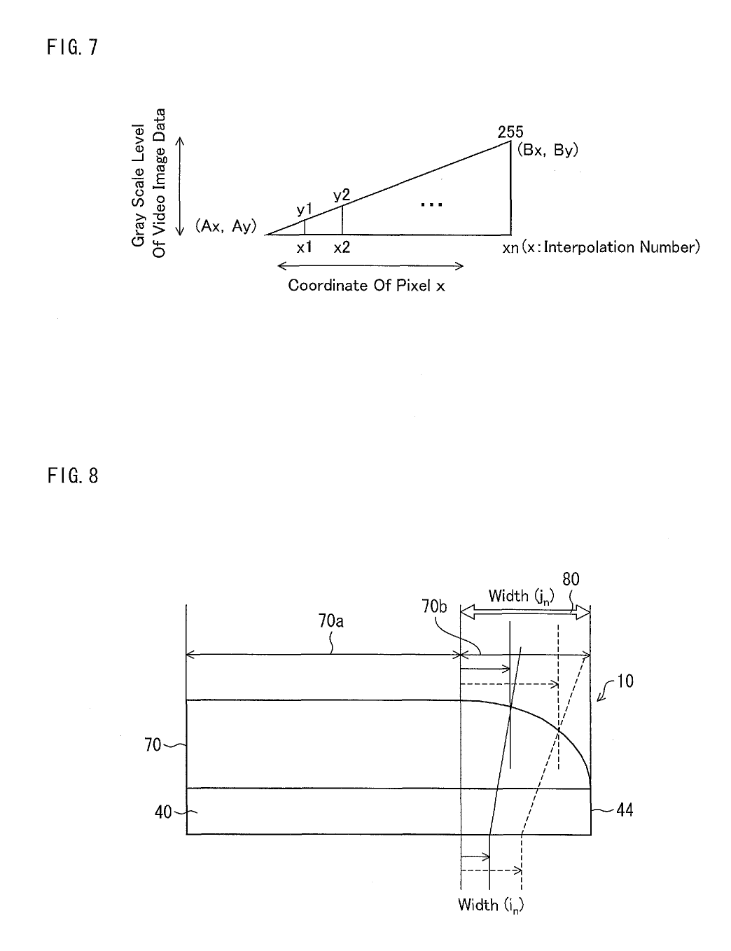

The description below deals in detail with interpolation video image data with reference to the FIGS. 6 and 7. FIG. 6 is a diagram illustrating original video image data and interpolation video image data. FIG. 6 shows (i) original video image data in its left side column and (ii) original video image data and interpolation video image data in its right side column. FIG. 7 is a diagram schematically illustrating how interpolation video image data is prepared.

The following describes an example case of preparing interpolation video image data as video image data having a gray scale level that is between respective gray scale levels of adjacent pixels belonging to respective lines adjacent to each other in the direction in which the curved region 70b of the lens 70 is curved along its curved surface.

The pixels adjacent to each other in the direction in which the curved region 70b is curved along its curved surface refer to pixels adjacent to each other in the direction extending, in a side view of the curved surface of the curved region 70b of the lens 70, from (i) the start end (that is, the boundary between the flat region 70a and the curved region 70b) of the curve of the curved surface to (ii) the rear end of the curve.

The interpolation video image data may be prepared by any of various methods. The description below first deals with a method for preparing interpolation video image data on the basis of a linear function.

FIG. 7 indicates (i) along its abscissa, pixel coordinates and (ii) along its ordinate, brightness (gray scale levels) for video image data. (Ax,Ay), for example, represents a pixel A having a coordinate of x and a gray scale level of y.

FIG. 7 schematically illustrates a case of preparing, between the pixel A (Ax,Ay) and the pixel B (Bx,By), interpolation video image data having an interpolation number of x.

Specifically, in the case where reference data is (Ax,Ay) and (Bx,By) and the interpolation number is x, interpolation video image data y is represented by the equation below.

y=ax+Ay :a=(By−Ay)/x

Thus, n-th interpolation video image data is represented by the equation below.

yₙ=axₙ+Ay

The interpolation video image data is, as described above, prepared as video image data having a gray scale level obtained by, for example, equally dividing the difference between respective gray scale levels for original video image data for adjacent pixels by the above interpolation number plus one (1). In the case where a plurality of interpolation video image data items are prepared between a pair of adjacent pixels, the interpolation video image data items thus prepared have respective gray scale levels that continuously either increase or decrease in value in stages from (i) the gray scale level for original video image data for one of the adjacent pixels to (ii) the gray scale level for original video image data for the other pixel.

Interpolation video image data found by the above equation is stored in the video image RAM 24 described above.

(How to Find Interpolation Number)

The description below deals with how to find an interpolation number for preparation of interpolation video image data. The interpolation number may be determined by any of various methods.

(Method 1)

A first method is a method of incrementing an interpolation number by one (1) each time the following inequality is satisfied:

Width(jn)−Width(in)≧1

The following describes the above method with reference to FIG. 8. FIG. 8 is a diagram illustrating the first method for finding an interpolation number.

The first method assumes that Width(in) extends from the boundary between the flat region 70a and the curved region 70b while being divided into segments. The first method increments the interpolation number by one (1) each time Width(jn)−Width(in) exceeds the width of one (1) line zone, that is, the pixel pitch (see FIG. 8).

In the above method, the curved region 70b corresponds to an interpolation video image data preparation region 80, that is, a region for which interpolation video image data is to be prepared.

The above method prepares interpolation video image data in correspondence with the rate at which a video image is magnified. The above method thus easily allows video image data combining original video image data with interpolation video image data to have, with respect to the length of the display surface of a display section as viewed through the optical section, a density that is substantially equal to that for the original video image data with respect to the length of the display surface of the display section.

Further, the above method can prepare interpolation video image data (i) particularly for a portion that needs interpolation video image data and (ii) at a required density. This can reduce the number of interpolation video image data items to be prepared.

The above method, which can thus reduce the number of interpolation video image data items, can reduce a required capacity for the video image RAM 24.

(Method 2)

This method 2 prepares interpolation video image data having a uniform interpolation number (step number).

The above method 1 has a variation in the number of interpolation video image data items for each interval between lines. In contrast, the method 2 prepares interpolation video image data items in a uniform number for any interval between lines.

The number (that is, the above “uniform number”) of interpolation video image data items to be prepared is determined on the basis of the rate at which a video image displayed by pixels is magnified through the curved region 70b of the lens 70.

The above description of the method 1 deals with an example case of preparing interpolation video image data for only a portion of the display region 46 which portion corresponds to the curved region 70b of the lens 70.

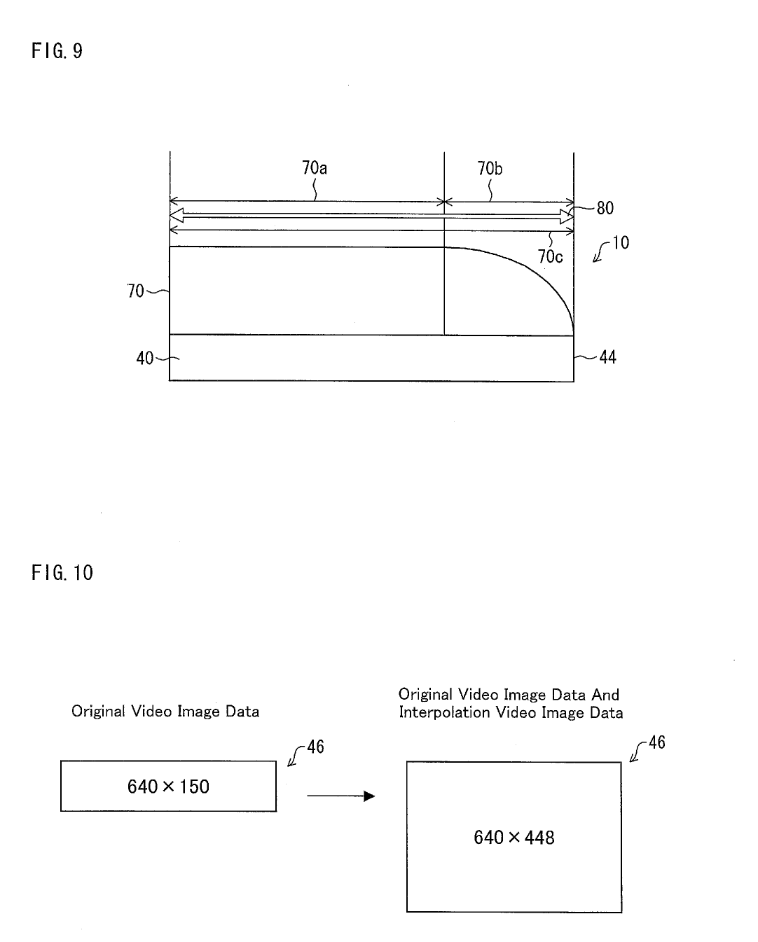

The description below deals with a contrasting example case of preparing interpolation video image data for not only a portion of the display region 46 which portion corresponds to the curved region 70b, but also a portion corresponding to the flat region 70a. Specifically, as illustrated in FIG. 9, which shows a region for which interpolation video image data is to be prepared, this example case prepares interpolation video image data for the entire region 70c of the lens 70, the entire region including the flat region 70a and the curved region 70b. Thus, the entire region 70c corresponds to the interpolation video image data preparation region 80.

FIG. 10 illustrates an example of preparing interpolation video image data by the method 2.

This example prepares interpolation video image data in an equal number for any interval between lines for the entire display region 46. Specifically, this example uses, as the lens 70, a lens having an approximate maximum magnification factor of an integer of two, which accordingly results in the interpolation number being two uniformly over the entire display region 46.

In other words, this example uses the number two for the number of interpolation video image data items as determined on the basis of the rate at which a video image displayed by pixels is magnified through the curved region 70b of the lens 70.

FIG. 10 illustrates, on its left side, an example display region 46 having pixels of 640×150. In this display region, original video image data has 150 lines.

FIG. 10 illustrates, on its right side, a pseudo display region 46 combining original video image data with interpolation video image data. Specifically, in the case where two interpolation video image data items are to be prepared for each interval between lines, the number of such interpolation video image data items to be prepared is given by

(150−1)×2=298.

Adding the number of original video image data items to the number of interpolation video image data items results in the sum of 448.

The display region 46 illustrated on the right side of the FIG. 10 corresponds to such a display region 46 having 448 lines.

This example prepares interpolation video image data between lines that extend in a row direction, but no interpolation video image data between lines that extend in a column direction.

This method can prepare interpolation video image data without requiring a complicated calculation, and can thus prepare interpolation video image data with use of a simple arithmetic circuit.

(Interpolation Video Image Data Preparation Region)

The description below deals with a region for which interpolation video image data is to be prepared. Such a region for which interpolation video image data is to be prepared may be any of various regions.

(Curved Region Only)

The above method 1 prepares interpolation video image data for, as an example, a region of the display region 46 which region extends from (i) the boundary between the flat region 70a and the curved region 70b to (ii) an end side 44 of the liquid crystal display panel 40.

This example prepares a minimally required number of interpolation video image data items, and can thus reduce a required capacity for the video image RAM 24.

(Entire Region)

The above method 2 deals with an example of preparing interpolation video image data for the entire display region 46.

(Portion of Flat Region and Curved Region)

The region for which interpolation video image data is to be prepared may be varied in addition to the above two examples.

For instance, interpolation video image data can be prepared for a region including the entire curved region 70b and a portion of the flat region 70a.

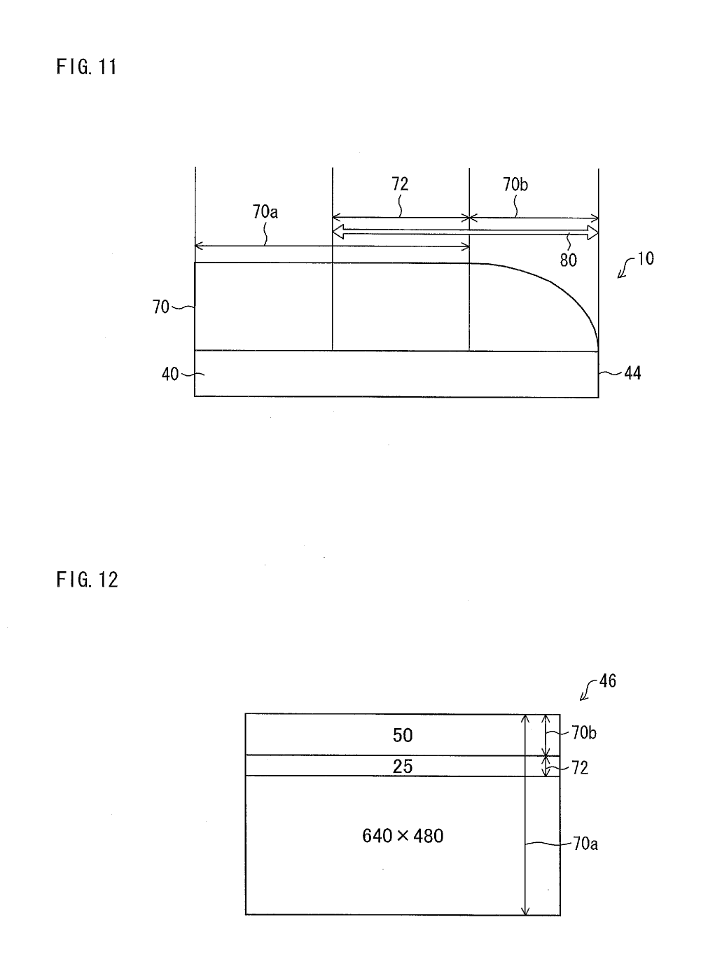

The description below refers to FIGS. 11 and 12. FIGS. 11 and 12 are each a diagram illustrating a region for which interpolation video image data is to be prepared.

The example illustrated in FIG. 11 prepares interpolation video image data for (i) the curved region 70b and (ii) an additional flat region 72, that is, a portion of the flat region 70a which portion is continuous with the curved region 70b. In other words, a region combining (i) the curved region 70b with (ii) the additional flat region 72 (that is, a region close to the boundary) corresponds to the interpolation video image data preparation region 80.

The additional flat region 72 is not particularly limited in size. The additional flat region 72 can have, for example, a size that is approximately half that of the curved region 70b.

The following describes details of the size of the additional flat region with reference to FIG. 12. FIG. 12 illustrates a display region 46 having pixels of 640×480. In the case where the curved region 70b in such a display region covers 50 lateral lines, the additional flat region 72 can be so sized as to cover approximately 25 lateral lines.

The additional flat region 72 is not limited in size as above. The additional flat region 72 may alternatively be designed to, for example, cover a larger number of lines.

Preparing interpolation video image data also for the additional flat region 72 as above can prevent display distortion, such as an extended display, occurring in the vicinity of the boundary between the flat region 70a and the curved region 70b.

In the case where the interpolation video image data preparation region 80 is set as illustrated in FIG. 11, the present embodiment does not particularly limit how to determine an interpolation number. Thus, either the method 1 or the method 2 can be used, for example.

(Selection of Thinned-Out Video Image Data)

The description below deals with selection of thinned-out data. This selection of thinned-out video image data refers to selecting, from original video image data and interpolation video image data described above with reference to FIG. 6, video image data to be used for an actual display. This selection of thinned-out video image data can prevent an extended display arising from the lens 70. This is described below in detail.

The selection of thinned-out video image data is based on the concept below.

Video image data items in a number necessary for display are selected, for the curved region 70b, from all video image data combining original video image data and interpolation video image data. The number necessary for display refers to the number of lines.

Thinned-out video image data is selected in such a manner that in the case where original video image data and interpolation video image data are arranged alternately, the selected thinned-out video image data items are positioned at substantially equal intervals.

Alternately arranging original video image data and interpolation video image data refers to (i) arranging original video image data items in order of respective corresponding pixels and further (ii) so arranging interpolation video image data items each between original video image data items corresponding to pixels that the gray scale levels are continuous with one another.

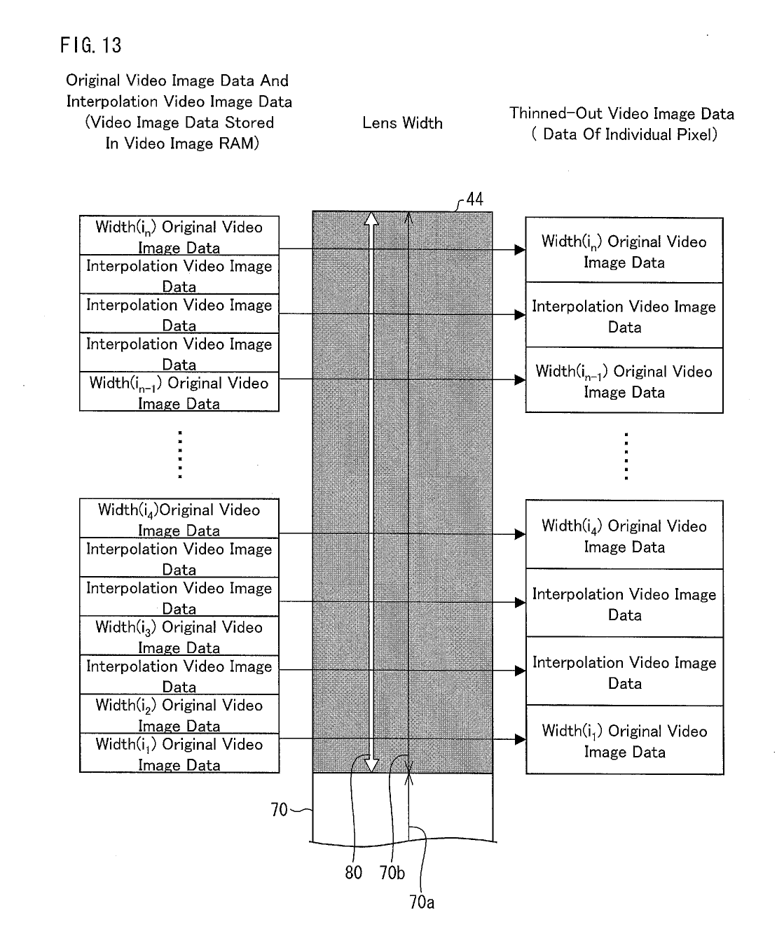

The following describes the above selection in detail with reference to FIG. 13. FIG. 13 is a diagram illustrating the selection of thinned-out video image data, and shows (i) on its left side column, video image data (video image data group) combining original video image data and interpolation video image data and (ii) on its right side column, thinned-out video image data.

FIG. 13 illustrates interpolation video image data that is similar to the interpolation video image data described above with reference to FIG. 6. The curved region 70b corresponds to the interpolation video image data preparation region 80 for the interpolation video image data shown in FIG. 13. The interpolation video image data is prepared by the method 1, that is, in such a manner that the number of interpolation video image data items prepared between adjacent lines increases from (i) the boundary between the flat region 70a and the curved region 70b to (ii) the end side 44.

The present embodiment selects, from original video image data and interpolation video image data, video image data items in a number necessary for display, that is, in a number equal to the number of lines. The present embodiment makes the above selection in such a manner that (i) original video image data items and interpolation video image data items are arranged alternately and that (ii) the selected video image data items are positioned at substantially equal intervals.

The above selection of thinned-out video image data makes it possible to easily select, as thinned-out video image data, display video image data, suitable for the lens width and line zone (pixel pitch), from video image data stored in the video image RAM 24. The lens width (i) refers to the length of a portion of the lens 70 which portion has curvature, and (ii) corresponds the length of the curved region 70b.

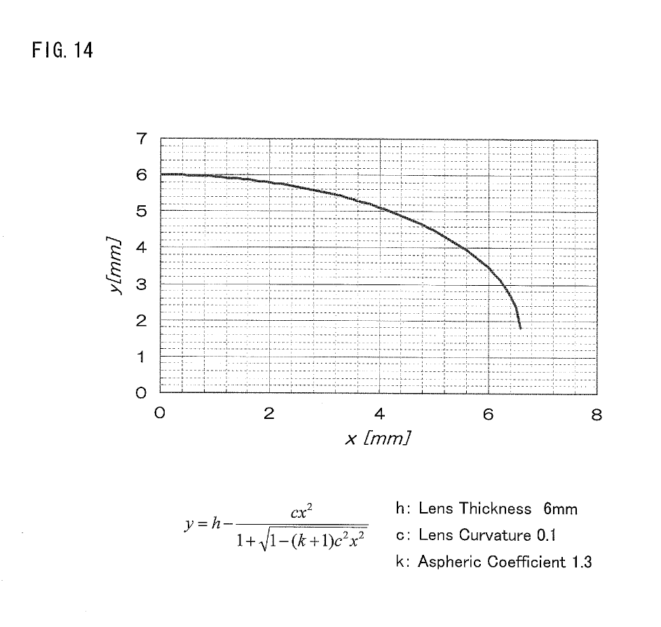

The following describes, as an example, the lens 70 and its lens width with reference to FIG. 14. FIG. 14 is a graph illustrating the relation between the radius of curvature of the lens 70 and its lens width. The graph of FIG. 14 shows (i) along its abscissa, the lens width, that is, the length of a portion of the lens 70 which portion has curvature, and (ii) along its ordinate, the radius of curvature of the lens.

FIG. 14 illustrates an example lens 70 having a thickness (lens thickness) of 6 mm and a lens width of 6.5 mm.

FIG. 14 shows an equation showing the relation between (i) the radius of curvature of the lens 70 and (ii) its lens width and the like.

In the case where the lens 70 dealt with in FIG. 14 as an example is used, the lens 70 illustrated in the middle column of FIG. 13 has (i) a lens width of 6.5 mm and (ii) a curved region 70b having a width of 6.5 mm. Since the curved region 70b corresponds to the interpolation video image data preparation region 80 in the example illustrated in FIG. 13, the interpolation video image data preparation region 80 also has a width of 6.5 mm.

The above description about the selection of thinned-out video image data deals with selection of thinned-out video image data for the curved region 70b on the assumption that interpolation video image data is prepared only for the curved region 70b.

In the case described above in relation to the method 2 for how to determine an interpolation number, that is, the case in which interpolation video image data is prepared not only for a portion of the display region 46 which portion corresponds to the curved region 70b, but also for a portion corresponding to the flat region 70a, the present embodiment may be arranged such that thinned-out video image data is not selected for the flat region 70a, but is selected only for the curved region 70b. In other words, the present embodiment may be arranged such that interpolation video image data is prepared for the flat region 70a, but only original video image data is directly used for display.

The above arrangement makes it possible to easily prepare interpolation video image data, and can thus achieve an excellent display both in the flat region 70a and the curved region 70b.

The inventors of the present invention have, however, found the following problem in the above arrangement of the reference embodiment: While the above arrangement prevents an extended display and thus achieves an excellent display when a display device is viewed in a direction normal thereto, it fails to sufficiently prevent an extended display when the display device is viewed in a direction inclined at an angle from the normal direction.

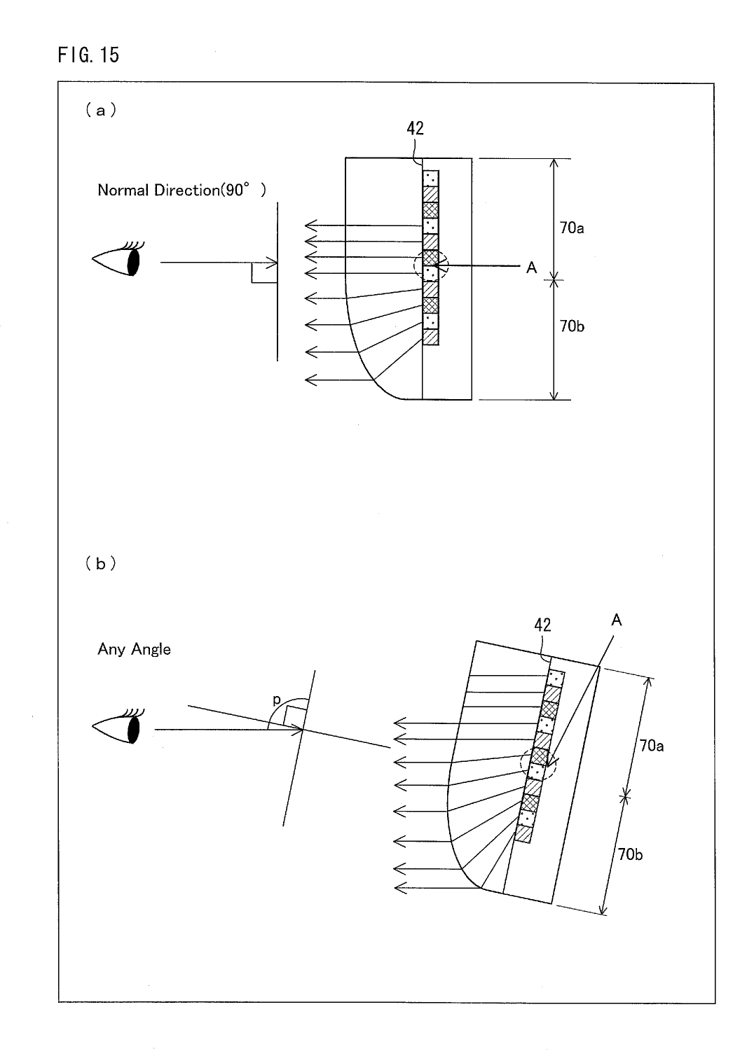

(a) of FIG. 15 is a diagram illustrating a display device being viewed in a direction normal thereto (that is, at a view angle of 90°). (b) of FIG. 15 is a diagram illustrating a display device being viewed in a direction (that is, at a view angle of p) inclined at an angle from the normal direction.

In the case where the view angle is 90° (that is, the display device is viewed in the normal direction) as illustrated in (a) of FIG. 15, the pixel section A circled by a broken line is displayed normally.

However, in the case where the view angle is p (that is, the display device is viewed in a direction inclined at an angle from the normal direction) as illustrated in (b) of FIG. 15, the pixel section A circled by a broken line displays an extended image. This is due to the following: Since light from the pixel section A facing the flat region 70a is outputted through the curved region 70b, an extended display is carried out in the flat region 70a, which is supposed to require no process of selecting thinned-out video image data.

The inventors of the present invention have further found the following problem in a display device including an arranged combinational pair of identical display panels: In the case where the view angle is different between the display panels adjacent to each other, while one of the display panels may prevent an extended display and carry out an excellent display, the other display panel may not carry out an excellent display.

In view of the above problems, the present invention provides a display device that can prevent an extended display attributed to a view angle and that is thus higher in reliability.

### Embodiment 1

The description below deals with Embodiment 1 with reference to the drawings. For convenience of explanation, members of the present embodiment that are identical in function to respective corresponding members described in the reference embodiment with reference to the drawings are each assigned a common reference numeral, and are not described here.

(Overall Configuration)

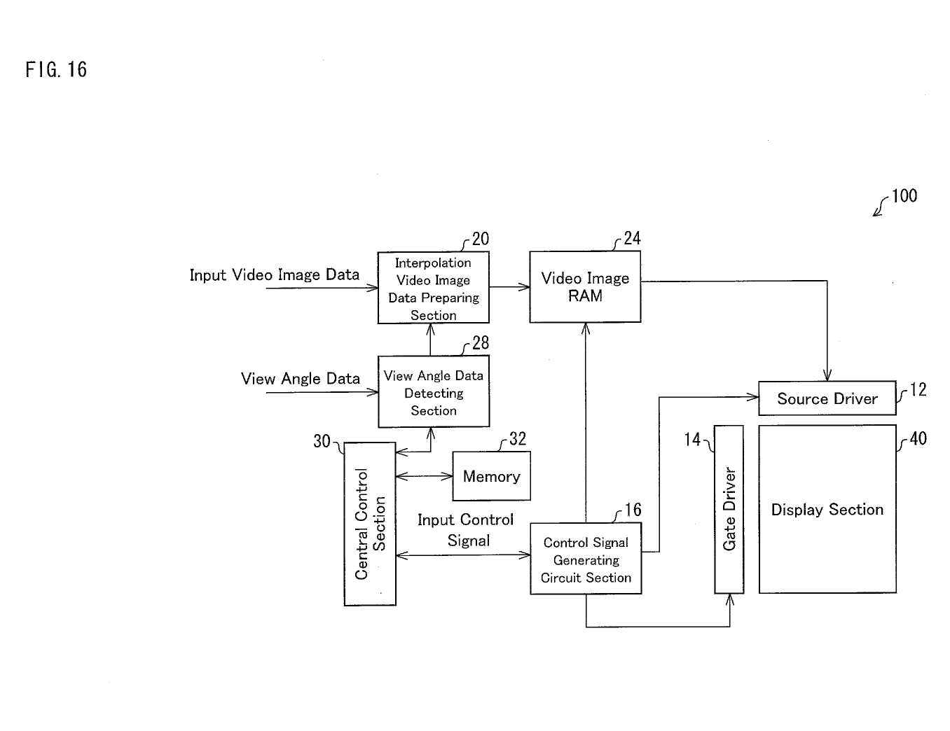

The description below now deals with an overall configuration of a liquid crystal display device 100 as a display device of the present embodiment with reference to FIG. 16. FIG. 16 is a block diagram schematically illustrating a configuration of the liquid crystal display device 100.

The liquid crystal display device 100 of the present embodiment includes various control sections and the like in addition to a liquid crystal display panel 40 serving as a display section.

Specifically, the liquid crystal display device, as illustrated in FIG. 16, includes a source driver 12 and a gate driver 14 both in a region surrounding the liquid crystal display panel 40.

The liquid crystal display device 100 further includes: a video image RAM 24 that stores video image data to be supplied to the source driver 12; and an interpolation video image data preparing section 20 connected to the video image RAM 24.

The interpolation video image data preparing section 20 prepares interpolation video image data. The video image RAM 24 stores (i) input video image data, that is, original video image data, and (ii) the interpolation video image data.

The original video image data (that is, video image data originally corresponding to individual pixels) refers to video image data that is supposed to be supplied to individual pixels. Specifically, the original video image data refers to, for example, video image data that would be supplied to individual pixels in a normal display device including no optical section such as a lens.

The video image data (namely, the original video image data and the interpolation video image data) is temporarily stored in the video image RAM, and is then supplied from the video image RAM 24 to the source driver 12.

The liquid crystal display device 100 further includes a control signal generating circuit section 16 that controls the source driver 12, the gate driver 14, and the video image RAM 24.

The control signal generating circuit section 16 functions also as a control section for selecting, from the video image data stored in the video image RAM 24, video image data to be supplied to the source driver 12 (that is, selecting thinned-out video image data).

The liquid crystal display device 100 further includes a view angle data detecting section 28 for detecting a view angle. The view angle refers to the angle of a user's line of sight with respect to the liquid crystal display device 100.

The view angle data detecting section 28 detects a view angle, and supplies data thereof to the interpolation video image data preparing section 20 and the central control section 30.

The interpolation video image data preparing section 20 prepares interpolation video image data in correspondence with the view angle data thus supplied.

The liquid crystal display device 100 further includes: a memory 32 that stores display control programs for performing the above control and the like; and a central control section 30 connected to the memory 32.

The central control section 30 controls the control signal generating circuit section 16 by supplying an input control signal thereto, and also controls the view angle data detecting section 28.

In the above-arranged liquid crystal display device 100 of the present Embodiment 1, the view angle data detecting section 28 detects the view angle of a user, and the interpolation video image data preparing section 20 prepares interpolation video image data in correspondence with that view angle. The liquid crystal display device can thus, even in the case where the view angle of a user does not correspond to the normal direction (90°), prevent an extended display attributed to a view angle. In other words, the liquid crystal display device 100 of the present embodiment is arranged differently from the above reference embodiment in that (i) it includes the view angle data detecting section 28 in addition to the members of the liquid crystal display device 10 of the reference embodiment and that (ii) the interpolation video image data preparing section 20 prepares interpolation data in correspondence with a view angle detected by the view angle data detecting section. The members other than the view angle data detecting section and the interpolation video image data preparing section may be identical to their respective corresponding members of the reference embodiment described above.

The description below deals in greater detail with how the present embodiment differs from the reference embodiment.

(Display Method)

The display method proposed in the reference embodiment assumes that the view angle corresponds to the normal direction. The present embodiment is, in contrast, intended for optimization with respect to a view angle in any direction. The following describes a display method for use in a display device of the present embodiment. The description below may refer to FIGS. 1 through 14 referred to in the reference embodiment.

(Magnification Factor)

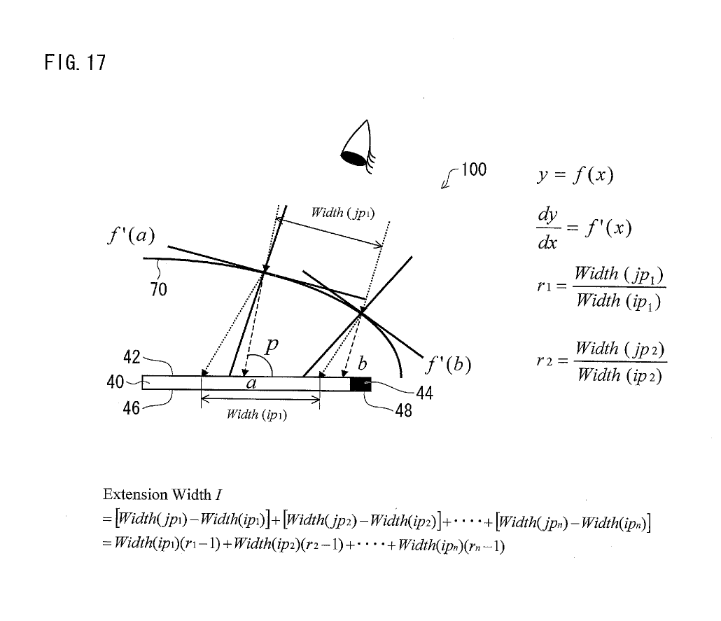

FIG. 17 is a diagram illustrating how the lens 70 magnifies a display.

In FIG. 17, Width(ipn) represents the width of a certain line zone (that is, the length of a portion of the display surface) for a case in which the view angle is p.

Width(jpn) represents the width of the line zone (that is, the length of the portion of the display surface) for a case in which Width(ipn) is displayed through the lens 70.

Width(jpn)/Width(ipn) gives a magnification factor rn for that line zone, that is, the rate at which a video image is magnified through the lens 70 serving as an optical section.

The magnification factor rn varies according to how the lens 70 is curved. Thus, the magnification factor rn varies for each line within the range from the boundary between the flat region 70a and the curved region 70b to the end side 44.

(Extension Width)

The description below now deals with the width by which a line zone is extended by the lens 70.

The extension width I by which a line zone is extended by the lens 70 is given by Width(jpn)−Width(ipn).

The extension width I for the entire curved region 70b is found by adding up all “Width(jpn)−Width(ipn)” values for that entire region as shown in the mathematical formula in FIG. 17.

f(x) in FIG. 17 is a function representative of the shape of a surface of the lens 70. f′(x) represents the inclination of f(x).

f′(a) and f′(b) in FIG. 17 represent respective inclinations of the surface of the lens 70 at positions a and b.

(View Angle Data)

The following describes view angle data. The view angle refers to the angle of a user's line of sight with respect to the display surface 42 of the liquid crystal display device 100. The view angle is represented by, for example, the angle p for inclination from the display surface 42 as illustrated in (b) of FIG. 15. Preparing interpolation video image data in correspondence with such view angle data makes it possible to prevent an extended display attributed to a view angle. This is described in detail.

(Interpolation Video Image Data)

Interpolation video image data refers to video image data prepared to fill a void formed as a result of video image extension by the lens 70. In other words, interpolation video image data refers to data so prepared in a pseudo manner as to, in a display region corresponding to a void formed as a result of video image extension by the lens 70, display a video image having a line zone substantially equal in width to such a void. Combining such interpolation video image data with original video image data, even in the case where the lens 70 has caused a video image to be extended by an extension width, allows prepared video image data to have, in a portion corresponding to the curved region 70b of the lens 70, a density that is substantially equal to that for a portion corresponding to the flat region 70a.

The extension width by which a line zone is extended by the lens 70 depends on the view angle p as described above.

The present embodiment prepares interpolation video image data in correspondence with the view angle p. Specifically, the interpolation video image data preparing section 20, upon receipt of view angle data, finds a solution of Width(jpn)−Width(ipn) to calculate the extension width. The interpolation video image data preparing section then prepares interpolation video image data in correspondence with the extension width.

The interpolation number for preparation of interpolation video image data may be determined by any of various methods such as the methods proposed in the reference embodiment, namely (i) the method of incrementing an interpolation number by one (1) each time the following inequality is satisfied:

Width(jpn)−Width(ipn)≧1,

and (ii) the method of preparing interpolation video image data having a uniform interpolation number (step number).

A specific example of the method for preparing interpolation video image data in correspondence with view angle data is described below.

This method first extracts a range of possible view angles different from one another by 5°, and calculates in advance respective extension widths for the extracted view angles. The method then, on the basis of the extension widths thus calculated, determines the number of interpolation video image data items for each of the view angles. The memory 32 and/or the like in the liquid crystal display device 100 stores information on the number of interpolation video image data items for each of the view angles different from one another by 5°. The interpolation video image data preparing section 20 then, (i) in correspondence with view angle data (that is, data on the view angle p) transmitted from the view angle data detecting section 28 and (ii) with reference to the stored information on the number of interpolation video image data items for each of the view angles different from one another by 5°, selects the number of interpolation video image data items for a view angle closest to the view angle p, and determines such interpolation video image data items as interpolation video image data for the view angle p.

The above example prepares interpolation video image data items for view angles different from one another by 5°. The present embodiment is, however, not necessarily limited to such an arrangement. Choosing a shorter interval, such as 1°, for the angles makes it possible to prepare interpolation video image data that is more accurate. A shorter interval for the angles, however, requires a larger portion of the memory capacity. The angles are thus preferably set to be different from one another by approximately 5°.

(Interpolation Video Image Data Preparation Region)

The description below deals with an interpolation video image data preparation region.

In the case where the view angle is p as illustrated in (b) of FIG. 15, since light from the pixel section A facing the flat region 70a is outputted through the curved region 70b, an extended display is carried out in the flat region 70a, which is supposed to require no process of selecting thinned-out video image data.

The present embodiment can thus use one of the ranges below as the interpolation video image data preparation region.

(Entire Region)

The present embodiment can prepare interpolation video image data for the entire display region 46.

(Portion of Flat Region and Curved Region)

The present embodiment can prepare interpolation video image data for a region including the entire curved region 70b and a portion of the flat region 70a.

(Selection of Thinned-Out Video Image Data)

The selection of thinned-out video image data refers to selecting, from original video image data and interpolation video image data as described in the reference embodiment, video image data to be used for an actual display. This selection of thinned-out video image data can prevent an extended display arising from the lens 70.

In the case where the view angle corresponds to a direction inclined at an angle from the normal direction as described above, an extended display may be carried out in the flat region 70a, which is supposed to require no process of selecting thinned-out video image data. The selection of thinned-out video image data is thus preferably intended for either the entire display region 46 or a region including the entire curved region 70b and a portion of the flat region 70a.

(How View Angle Data Detecting Section Detects View Angle)

The description below deals with how the view angle data detecting section 28 detects a view angle. The view angle data detecting section 28 detects the view angle p of a user with respect to the liquid crystal display device 100, and supplies data of the view angle p to the interpolation video image data preparing section 20 and the central control section 30. The interpolation video image data preparing section 20 prepares interpolation video image data in correspondence with the view angle data, and supplies the interpolation video image data to, for example, the video image RAM 24 (which may be omitted).

The following describes how the view angle data detecting section 28 of the present embodiment detects the view angle of a user.

The description below deals with an example of a fold-type liquid crystal display device 100 such as a note-type PC and a fold-type mobile telephone.

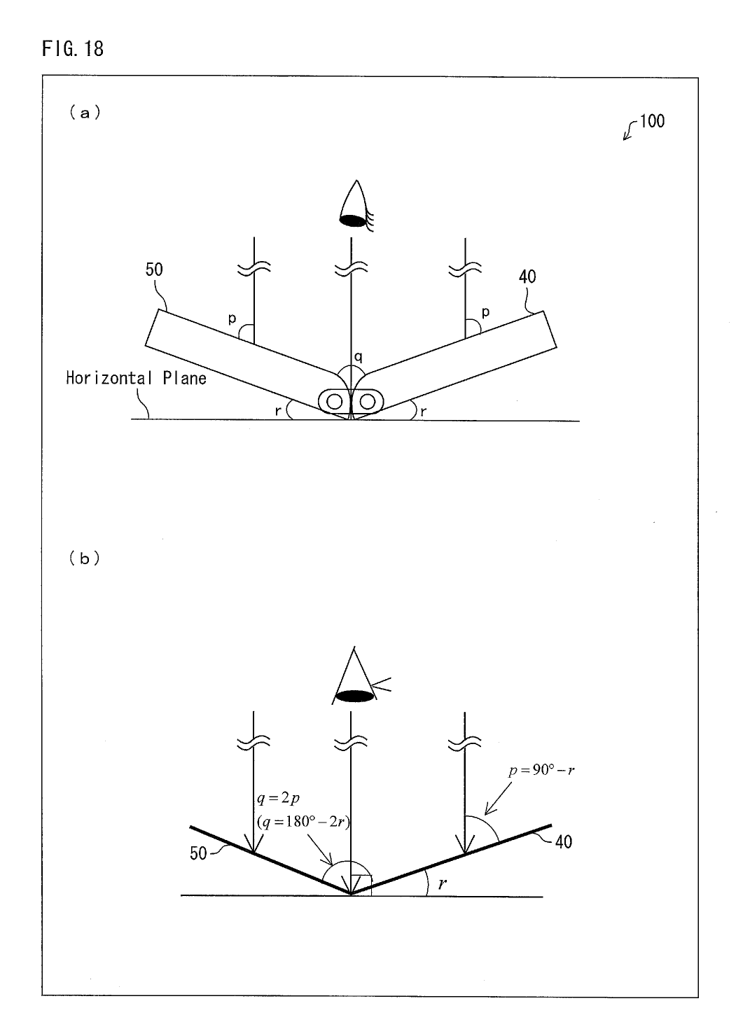

(a) of FIG. 18 schematically illustrates a configuration of the fold-type liquid crystal display device 100 and the direction of a user's line of sight with respect to the fold-type liquid crystal display device.

The fold-type liquid crystal display device 100, as illustrated in (a) of FIG. 18, includes: the above-described liquid crystal display panel 40; and an operation button group or keyboard, that is, an operating section 50 for use in operation of the liquid crystal display device 100. (a) of FIG. 18 illustrates the liquid crystal display device 100 having an open angle q and placed in such a manner that the liquid crystal display panel 40 and the operating section 50 each have an angle r with respect to the horizontal plane.

(b) of FIG. 18 illustrates a relation, observed in the state illustrated in (a) of FIG. 18, between (i) the open angle q between the liquid crystal display panel 40 and the operating section 50 of the fold-type liquid crystal display device 100 and (ii) a user's view angle p (that is, the angle formed by the direction of the line of sight with respect to a surface of the liquid crystal display panel 40). In the case where the direction of the line of sight corresponds to the direction normal to the point at which the liquid crystal display panel 40 is connected to the operating section 50, (i) the relational equation q=180°−2r is satisfied, as illustrated in (b) of FIG. 18, between the open angle q and the angle r with respect to the horizontal plane, and (ii) the relational equation q=2p is satisfied between the open angle q and the view angle p. This indicates that detecting the open angle q allows the view angle p to be determined.

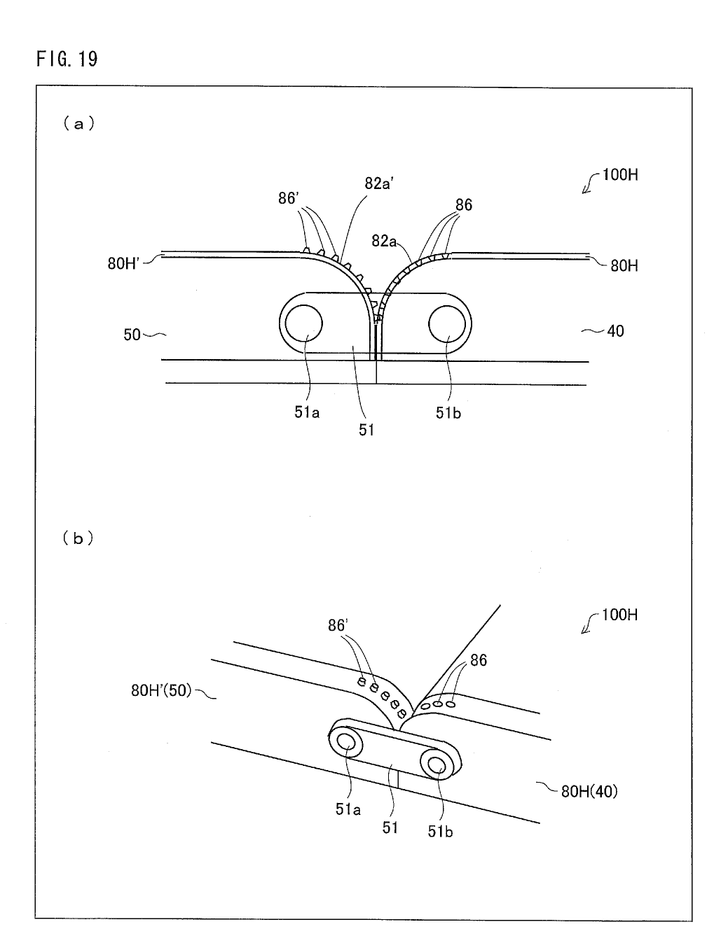

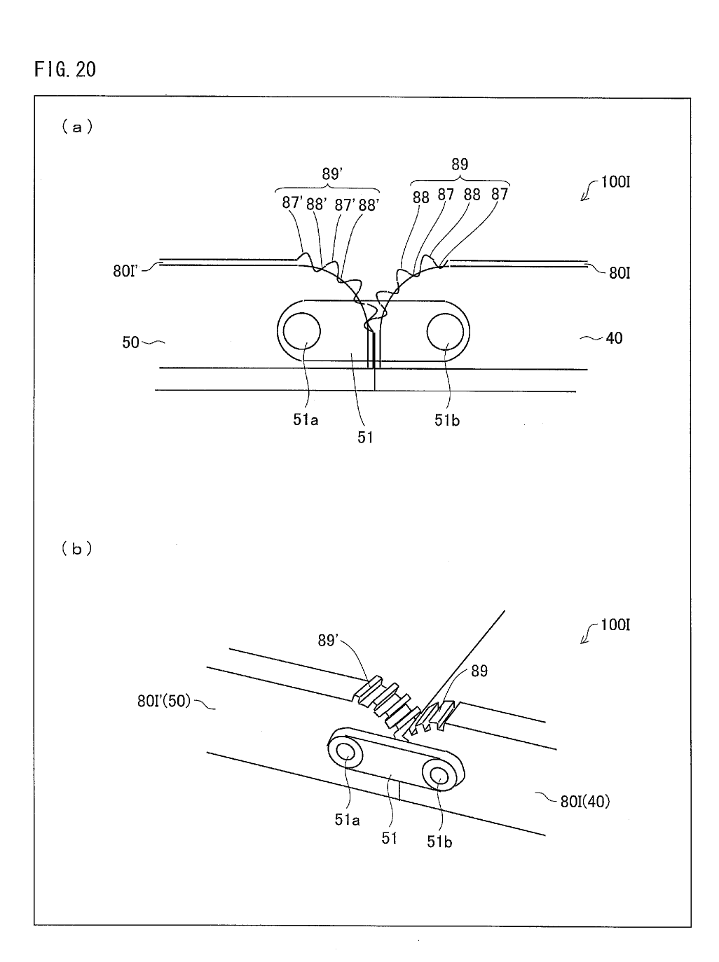

The following describes, with reference to FIGS. 19 and 20, a method used in the liquid crystal display device 100 for detecting an open angle q of the liquid crystal display device.

(a) and (b) of FIG. 19 each illustrate a liquid crystal display device 100H as an example of the liquid crystal display device 100. The liquid crystal display device 100H includes: a housing 80H having a curved-surface housing section 82H provided with a plurality of concave sections 86 on an observer-side front surface 82a; and a housing 80H′ having a curved-surface housing section 82H′ provided with a plurality of convex sections 86′ on an observer-side front surface 82a′. The description below assumes, as an example, that the housings 80H and 80H′ contain the liquid crystal display panel 40 and the operating section 50, respectively. The housings 80H and 80H′ may alternatively contain the operating section and the liquid crystal display panel, respectively.

The housings 80H and 80H′ are connected to each other with a biaxial hinge 51. The housings 80H and 80H′ are arranged to be rotatable about hinge shafts 51a and 51b, respectively, each serving as a rotation axis. Rotating the housings 80H and 80H′ can change the open angle q of the liquid crystal display device 100H. The convex sections 86′ and the concave sections 86 are provided in such a pattern as to engage with each other in a one-to-one correspondence as the open angle q of the liquid crystal display device 100H is gradually decreased.

The view angle data detecting section 28 can be a switch provided between the convex sections 86′ and the concave sections 86. The view angle data detecting section senses the open angle q of the liquid crystal display device on the basis of contact between the convex sections 86′ and the concave sections 86. The view angle data detecting section can thus calculate the view angle p on the basis of the equation indicative of the relation between the open angle q and the view angle p. The view angle data detecting section obtains view angle data as above, and supplies the view angle data to the interpolation video image data preparing section 20 and the central control section 30.

(a) and (b) of FIG. 20 each illustrate a liquid crystal display device 100I as an example of the liquid crystal display device 100. The liquid crystal display device 100I includes: a housing 80I having a housing section 82I provided with a first convexo-concave structure 89; and a housing 80I′ having a housing section 821′ provided with a second convexo-concave structure 89′. The description below assumes, as an example, that the housings 80I and 80I′ contain the liquid crystal display panel 40 and the operating section 50, respectively. The housings 80I and 80I′ may alternatively contain the operating section and the liquid crystal display panel, respectively.

The housings 80I and 80I′ are connected to each other with a biaxial hinge 51. The housings 80I and 80I′ are arranged to be rotatable about hinge shafts 51a and 51b, respectively, each serving as a rotation axis.

The first convexo-concave structure 89 includes a plurality of concave sections 87 and a plurality of convex sections 88 provided alternately one by one. The second convexo-concave structure 89′includes a plurality of convex sections 87′ and a plurality of concave sections 88′ provided alternately one by one. The first convexo-concave structure 89 and the second convexo-concave structure 89′ are so provided as to engage with each other.

Rotating the housings 80I and 80I′ can change the open angle q of the liquid crystal display device 100I. The first convexo-concave structure 89 include concaves and convexes which engage with concaves and convexes of the second convexo-concave structure 89′ in a one-to-one correspondence as the open angle q of the liquid crystal display device 100I is gradually decreased.

In this case as well as the case of the liquid crystal display device 100H, the view angle data detecting section 28 can be a switch between the first convexo-concave structure 89 and the second convexo-concave structure 89′. The view angle data detecting section senses the open angle q of the liquid crystal display device on the basis of contact between the first convexo-concave structure 89 and the second convexo-concave structure 89′. The view angle data detecting section can thus calculate the view angle p on the basis of the equation indicative of the relation between the open angle q and the view angle p. The view angle data detecting section obtains view angle data as above, and supplies the view angle data to the interpolation video image data preparing section 20 and the central control section 30.

The above liquid crystal display device 100 may be arranged to directly detect a view angle p and prepare interpolation video image data on the basis of data of the detected view angle.

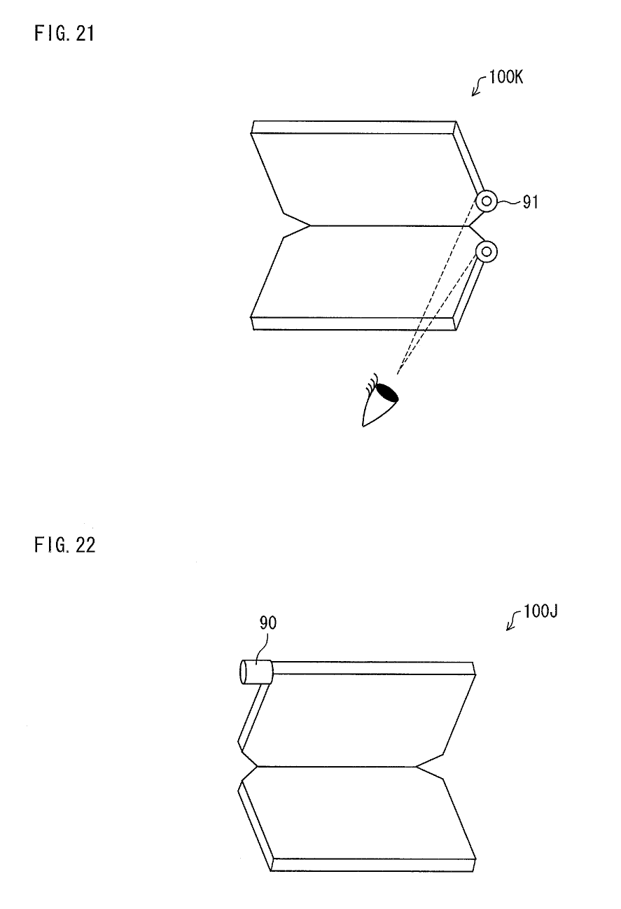

FIG. 21 illustrates a liquid crystal display device 100K as an example of the liquid crystal display device 100. The liquid crystal display device 100K includes a sensor 91 for sensing the position of an eyeball. The liquid crystal display device 100K detects a view angle p with use of the sensor 91, and supplies data of the detected view angle to the interpolation video image data preparing section 20 and the central control section 30.

The above variations of the liquid crystal display device 100 each (i) detect a view angle p, (ii) prepare interpolation video image data on the basis of the view angle p, and then (iii) select, from the original video image data and the interpolation video image data, video image data items (thinned-out video image data items) in a number necessary for display.

The liquid crystal display device 100 preferably includes a manual adjustment section so that a user manually adjusts the manual adjustment section to reselect thinned-out video image data.

The above arrangement can further reliably and optimally adjust a display for the liquid crystal display device 100. In other words, finely adjusting the manual adjustment section can (i) further reliably prevent an extended display that cannot be completely prevented through a display control by the central control section 30 and (ii) achieve an optimal display.

FIG. 22 illustrates, as an example, a liquid crystal display device 100J that includes a manual volume 90 (manual adjustment section). The user can operate the manual volume 90 to reselect thinned-out video image data so that the liquid crystal display device 100 carries out an optimal display.

### Embodiment 2

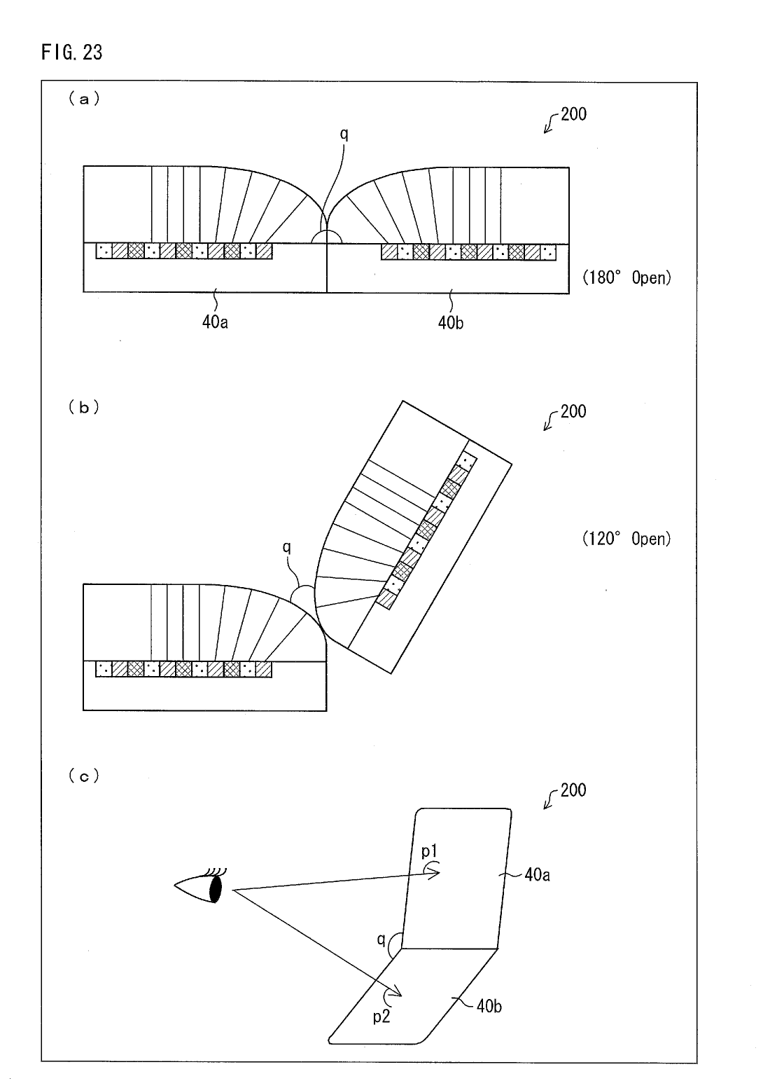

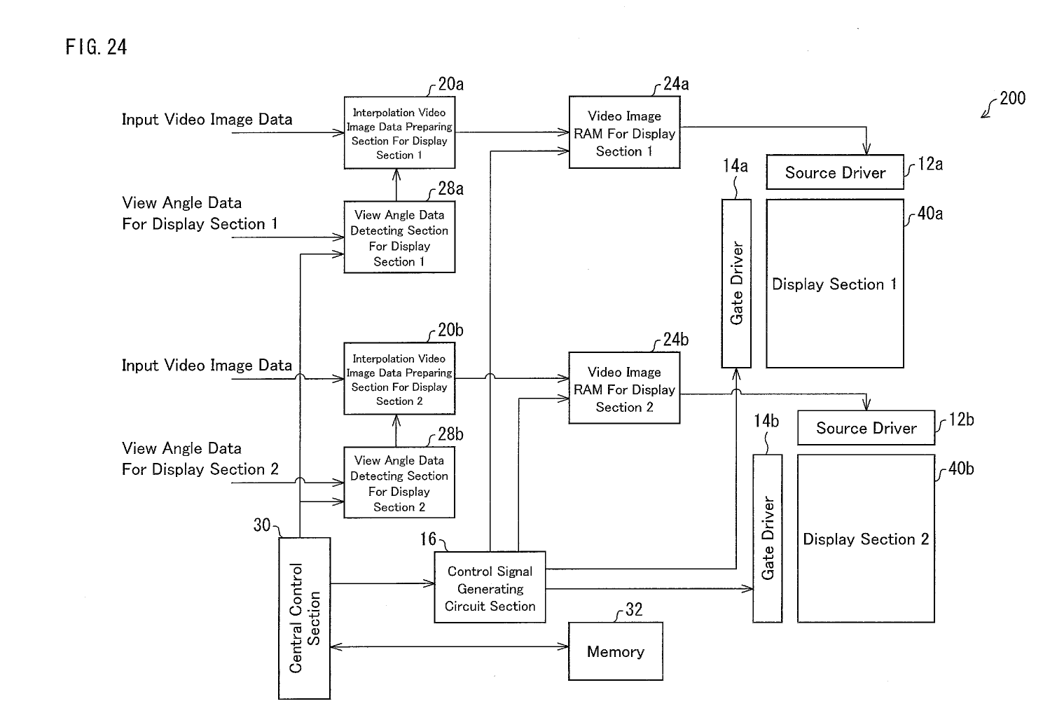

Another embodiment of the display device of the present invention is described below with reference to FIGS. 23 and 24.

For convenience of explanation, members of the present embodiment that are identical in function to respective corresponding members described in Embodiment 1 above with reference to the drawings are each assigned a common reference numeral, and are not described here.

(a) and (b) of FIG. 23 are each a view schematically illustrating a liquid crystal display device 200 of the present embodiment. As illustrated in these views, the liquid crystal display device 200 is a fold-type display device including two display sections: a display section 1 (liquid crystal display panel 40a) and a display section 2 (liquid crystal display panel 40b). (a) of FIG. 23 illustrates the liquid crystal display device having an open angle q of 180°, whereas (b) of FIG. 23 illustrates the liquid crystal display device having an open angle q of 120°.

In the case where, for instance, the liquid crystal display device 200 having the above arrangement is used in a state in which it is bent at an open angle q as illustrated in (c) of FIG. 23, a view angle p1 with respect to the display section 1 is different from a view angle p2 with respect to the display section 2.

The liquid crystal display device of the present embodiment processes interpolation video image data and selects thinned-out video image data for the two display sections independently of each other to achieve an optimal display in each of the two display sections. This point is described below.

(Overall Configuration)

FIG. 24 is a block diagram schematically illustrating a configuration of the liquid crystal display device 200.

The liquid crystal display device 200 of the present embodiment, as illustrated in FIG. 24, includes a liquid crystal display panel 40a and a liquid crystal display panel 40b each as a display section.

The liquid crystal display device includes (i) a source driver 12a and a gate driver 14a both in a region surrounding the liquid crystal display panel 40a serving as the display section 1 and (ii) a source driver 12b and a gate driver 14b in a region surrounding the liquid crystal display panel 40b serving as the display section 2.

The liquid crystal display device 200 further includes (i) a video image RAM 24a for the display section 1 which video image RAM 24a stores video image data to be supplied to the source driver 12a and (ii) a video image RAM 24b for the display section 2 which video image RAM 24b stores video image data to be supplied to the source driver 12b.

The video image RAM 24a for the display section 1 is connected to an interpolation video image data preparing section 20a for the display section 1 (first interpolation video image data preparing section). The video image RAM 24b for the display section 2 is connected to an interpolation video image data preparing section 20b for the display section 2 (second interpolation video image data preparing section).

The interpolation video image data preparing section 20a for the display section 1 and the interpolation video image data preparing section 20b for the display section 2 each prepare interpolation video image data. The video image RAM 24a for the display section 1 and the video image RAM 24b for the display section 2 each store input video image data, that is, original video image data, and the interpolation video image data.

The video image data (namely, the original video image data and the interpolation video image data) is temporarily stored in the video image RAM 24a for the display section 1 and the video image RAM 24b for the display section 2, and is then supplied from the video image RAM 24a for the display section 1 and the video image RAM 24b for the display section 2 to the source driver 12a and the source driver 12b, respectively.

The liquid crystal display device 200 further includes a control signal generating circuit section 16 that controls the source driver 12a, the source driver 12b, the gate driver 14a, the gate driver 14b, the video image RAM 24a for the display section 1, and the video image RAM 24b for the display section 2.

The control signal generating circuit section 16 functions also as a control section for selecting, from the video image data stored in the video image RAM 24a for the display section 1 and the video image RAM 24b for the display section 2, video image data to be supplied to the source driver 12a and the source driver 12b (that is, selecting thinned-out video image data).

The liquid crystal display device 200 further includes (i) a view angle data detecting section 28a for the display section 1 (first viewing angle data detecting section) and (ii) a view angle data detecting section 28b for the display section 2 (second viewing angle data detecting section) each of which view angle data detecting sections detects a view angle.

The view angle data detecting section 28a for the display section 1 detects the view angle p1 of a user with respect to the display section 1, and supplies data of the view angle to the interpolation video image data preparing section 20a for the display section 1. The view angle data detecting section 28b for the display section 2 detects the view angle p2 of the user with respect to the display section 2, and supplies data of the view angle to the interpolation video image data preparing section 20b for the display section 2.

The interpolation video image data preparing section 20a for the display section 1 and the interpolation video image data preparing section 20b for the display section 2 each prepare interpolation video image data in correspondence with the supplied view angle data. How interpolation video image data is prepared for the display sections is similar to the method described in Embodiment 1.

The liquid crystal display device 200 further includes: a memory 32 that stores display control programs for performing the above control and the like; and a central control section 30 connected to the memory 32.

The central control section 30 controls the control signal generating circuit section 16 by supplying an input control signal thereto, and also controls the view angle data detecting sections 28a and 28b.

The liquid crystal display device 200 of the present Embodiment 2, with the above arrangement, allows a fold-type display device including a display section 1 and a display section 2 to (i) detect respective view angles p1 and p2 with respect to the display section 1 and the display section 2 and (ii) prepare interpolation video image data in correspondence with data of the individual view angles. The above arrangement can thus, for each of the two display sections, prevent an extended display attributed to a view angle.

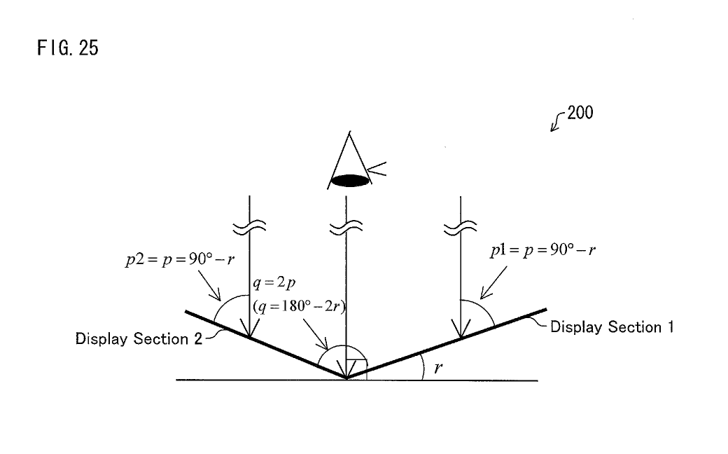

The following describes, with reference to FIG. 25, details of how the view angles p1 and p2 are detected in the fold-type display device including the display section 1 and the display section 2.

FIG. 25 illustrates an example case in which the liquid crystal display device 200 having an open angle q is placed on a horizontal plane in such a manner that the display section 1 and the display section 2 each have an angle r with respect to the horizontal plane.

In the case where the direction of the line of sight corresponds to the direction normal to the point at which the display section 1 is connected to the display section 2, (i) the relational equation q=180°2r is satisfied between the open angle q and the angle r with respect to the horizontal plane, and (ii) the relational equations p=p1=p2 and q=2p are satisfied between the open angle q and the view angle p. Thus, the view angle data detecting section 28a for the display section 1 and the view angle data detecting section 28b for the display section 2 detect an open angle q, and determine the respective view angles p1 and p2 with respect to the display section 1 and display section 2 on the basis of the relational equations.

The interpolation video image data preparing section 20a for the display section 1 and the interpolation video image data preparing section 20b for the display section 2 then prepare interpolation video image data in correspondence with supplied data of the view angles (p1 and p2).

The liquid crystal display device may alternatively be arranged such that (i) the display section 1 and the display section 2 each include a sensor for sensing the position of an eyeball in order to detect the respective view angles p1 and p2 with respect to the display section 1 and the display section 2 with use of the sensors and that (ii) the interpolation video image data preparing section 20a for the display section 1 and the interpolation video image data preparing section 20b for the display section 2 prepare interpolation video image data in correspondence with supplied data of the view angles (p1 and p2).

The display device 200 preferably includes a manual adjustment section so that a user manually adjusts the manual adjustment section to reselect thinned-out video image data.

The manual adjustment section may be a manual volume. This manual volume allows symmetric cooperation between the display section 1 and the display section 2 placed on top of (or next to) each other. The manual volume may thus be provided in a number of one (1).

The above arrangement can further reliably and optimally adjust a display for the display device 200.

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

The display device of the present invention may preferably be arranged such that the interpolation video image data preparing section determines a number of the interpolation video image data item to be prepared on a basis of a rate at which a video image displayed from the plurality of pixels at the view angle detected by the view angle data detecting section is magnified through the curved region of the optical section.

The above arrangement causes the number of interpolation video image data items to be a value suitable for (i) the angle for an observer's line of sight with respect to the display surface and (ii) the shape of the curved surface of the optical section. Thus, in the case where interpolation video image data items and original video image data items are arranged as described above, the resulting video image data group is not likely to result in an extended display through a lens. The above arrangement can thus, even in the case where the observer's view angle changes variously, prevent an extended display in correspondence with the view angle.

The display device of the present invention may preferably be arranged such that the view angle data detecting section senses a position of an eyeball of the observer so as to detect the view angle and prepare the view angle data.

The above arrangement facilitates detecting a view angle.

The display device of the present invention may be arranged such that the display device further includes an operating section for operating the display device; the display device is a fold-type display device that is foldable to such a position that the display section and the operating section face each other; and the view angle data detecting section (i) detects an open angle between the display section and the operating section and (ii) prepares the view angle data on a basis of the open angle.

The above arrangement can, in a fold-type display device such as a note-type PC and a fold-type mobile telephone, detect an open angle between the display section and the operating section to prepare view angle data.

The display device of the present invention may be arranged such that the display section includes two display sections; the view angle data detecting section includes (i) a first view angle data detecting section for detecting a view angle for a first one of the two display sections and preparing view angle data and (ii) a second view angle data detecting section for detecting a view angle for a second one of the two display sections and preparing view angle data; and the interpolation video image data preparing section includes (i) a first interpolation video image data preparing section for preparing an interpolation video image data item for the first display section and (ii) a second interpolation video image data preparing section for preparing an interpolation video image data item for the second display section.

The above arrangement can, in a fold-type display device including two display sections, (i) detect respective view angles for the two display sections and (ii) prepare interpolation video image data in correspondence with data of the individual view angles. The above arrangement can thus, in each of the two display sections, prevent an extended display attributed to a view angle.

The display device of the present invention may preferably be arranged such that the display device further includes a manual adjustment section; and the observer adjusts the manual adjustment section to reselect, from the video image data items combining the plurality of original video image data items and the interpolation video image data, video image data items in the number equal to the number of the pixels.

The above arrangement can further reliably and optimally adjust a display for the above display device. In other words, finely adjusting the manual adjustment section can (i) further reliably prevent an extended display that cannot be completely prevented through an automatic display control and (ii) achieve an optimal display.

The display device of the present invention may preferably be arranged such that the interpolation video image data preparing section prepares, with respect to the pixels adjacent to each other, the interpolation video image data item for (i) a region facing the curved region and (ii) a region in a vicinity of a boundary between the curved region and the flat region.

In the case where there is variation in the angle of the observer's line of sight with respect to the display section, a display tends to be extended not only in the curved region but also in the vicinity of the boundary between the flat region and the curved region. The above arrangement prepares interpolation video image data also for a region in the vicinity of the boundary between the curved region and the flat region, and can consequently prevent display distortion, such as an extended display, occurring in the vicinity of the boundary between the flat region and the curved region.

The display device of the present invention may preferably be arranged such that the interpolation video image data preparing section prepares the interpolation video image data item for an entire region of the display surface of the display section.

In the case where there is variation in the angle of the observer's line of sight with respect to the display section, a display tends to be extended also in a region other than the curved region. The above arrangement prepares interpolation video image data for the entire region of the display surface, and can consequently prevent display distortion, such as an extended display, occurring in any of the entire region of the display surface.

The display device of the present invention may preferably further include: a video image RAM for storing the plurality of original video image data items and the interpolation video image data item, wherein: the control section selects, from the plurality of original video image data items and the interpolation video image data both stored in the video image RAM, video image data for use in a display.

The above arrangement includes a video image RAM that stores the original video image data items and the interpolation video image data items. This allows the control section to have a simplified configuration.

### INDUSTRIAL APPLICABILITY

The display device of the present invention can prevent an extended display with use of a simple configuration, and is thus suitably applicable to, for example, a portable terminal, such as a game terminal, that includes a display section.

### Reference Signs List

10 liquid crystal display device
12 source driver
14 gate driver
16 control signal generating circuit section (control section)
20 interpolation video image data preparing section
28 view angle data detecting section
30 central control section
32 memory
40 liquid crystal display panel
100 liquid crystal display device
200 liquid crystal display device

1. A display device comprising:
a display section; and
an optical section covering a display surface of the display section,
the display section including a plurality of pixels arranged in a matrix,
the optical section including a lens having (i) a flat region having a flat front surface and (ii) a curved region having a curved convex front surface,
video image data items for the plurality of respective pixels being a plurality of original video image data items,
the display device further comprising:
a view angle data detecting section for detecting a view angle, which is an angle for a line of sight by an observer with respect to the display section, so as to prepare view angle data;
an interpolation video image data preparing section for preparing, on a basis of the view angle data, an interpolation video image data item, which is a video image data item having a gray scale level that is between respective gray scale levels of individual original video image data items for pixels adjacent to each other; and
a control section for selecting, from video image data items combining (i) the plurality of original video image data items arranged in an order of respective pixels corresponding to the plurality of original video image data items and (ii) the interpolation video image data item located between original video image data items for respective corresponding pixels so that a gray scale level of the interpolation video image data item is continuous with respective gray scale levels of the original video image data items for said respective corresponding pixels, video image data items (i) in a number equal to a number of the pixels and (ii) at a substantially equal interval.

2. The display device according to claim 1, wherein:
the interpolation video image data preparing section determines a number of the interpolation video image data item to be prepared on a basis of a rate at which a video image displayed from the plurality of pixels at the view angle detected by the view angle data detecting section is magnified through the curved region of the optical section.

3. The display device according to claim 1, wherein:
the view angle data detecting section senses a position of an eyeball of the observer so as to detect the view angle and prepare the view angle data.

4. The display device according to claim 1, wherein:
the display device further includes an operating section for operating the display device;
the display device is a fold-type display device that is foldable to such a position that the display section and the operating section face each other; and
the view angle data detecting section (i) detects an open angle between the display section and the operating section and (ii) prepares the view angle data on a basis of the open angle.

5. The display device according to any one of claims 1, wherein:
the display section includes two display sections;
the view angle data detecting section includes (i) a first view angle data detecting section for detecting a view angle for a first one of the two display sections and preparing view angle data and (ii) a second view angle data detecting section for detecting a view angle for a second one of the two display sections and preparing view angle data; and
the interpolation video image data preparing section includes (i) a first interpolation video image data preparing section for preparing an interpolation video image data item for the first display section and (ii) a second interpolation video image data preparing section for preparing an interpolation video image data item for the second display section.

6. The display device according to claim 1, wherein:
the display device further includes a manual adjustment section; and
the observer adjusts the manual adjustment section to reselect, from the video image data items combining the plurality of original video image data items and the interpolation video image data, video image data items in the number equal to the number of the pixels.

7. The display device according to claim 1, wherein:
the interpolation video image data preparing section prepares, with respect to the pixels adjacent to each other, the interpolation video image data item for (i) a region facing the curved region and (ii) a region in a vicinity of a boundary between the curved region and the flat region.

8. The display device according to claim 1, wherein:
the interpolation video image data preparing section prepares the interpolation video image data item for an entire region of the display surface of the display section.

9. The display device according to claim 1, further comprising:
a video image RAM for storing the plurality of original video image data items and the interpolation video image data item,
wherein:
the control section selects, from the plurality of original video image data items and the interpolation video image data both stored in the video image RAM, video image data for use in a display.

10. A method for use in a display device,
the display device comprising:
a display section; and
an optical section covering a display surface of the display section,
the display section including a plurality of pixels arranged in a matrix,
the optical section including a lens having (i) a flat region having a flat front surface and (ii) a curved region having a curved convex front surface,
video image data items originally corresponding to the plurality of respective pixels being a plurality of original video image data items,
the method comprising the steps of:
detecting a view angle, which is an angle for a line of sight by an observer with respect to the display section, so as to prepare view angle data;
preparing, on a basis of the view angle data, an interpolation video image data item, which is a video image data item having a gray scale level that is between respective gray scale levels of individual original video image data items for pixels adjacent to each other;
selecting, from video image data items combining (i) the plurality of original video image data items arranged in an order of respective pixels corresponding to the plurality of original video image data items and (ii) the interpolation video image data item located between original video image data items for respective corresponding pixels so that a gray scale level of the interpolation video image data item is continuous with respective gray scale levels of the original video image data items for said respective corresponding pixels, video image data items (i) in a number equal to a number of the pixels and (ii) at a substantially equal interval; and
displaying the selected video image data items.
